(19) United States
(12) Patent Application Publication
(10) Pub. No.: US 2007/0006081 A1
(43) Pub. Date: Jan. 4, 2007

(54) DISPLAY DEVICE AND METHOD OF ADJUSTING SOUNDS OF THE DISPLAY DEVICE

(75) Inventors: Minoru Maehata, Kobe-shi (JP); Kanako Nishida, Kobe-shi (JP); Momoko Fujiwara, Kobe-shi (JP)

Correspondence Address: FOGG AND ASSOCIATES, LLC, P.O. BOX 581339, MINNEAPOLIS, MN, 55458-1339, US

(73) Assignee: FUJITSU-TEN LIMITED, Hyogo (JP)

(21) Appl. No.: 11/427,445

(22) Filed: Jun. 29, 2006

(30) Foreign Application Priority Data
Jun. 30, 2005 (JP) 2005-193214
Jun. 20, 2006 (JP) 2006-170487

(51) Int. Cl. G06F 3/00; G06F 17/00; G06F 9/00

(52) U.S. Cl. 715/727

(57) ABSTRACT

A display device equipped with an acoustic control unit for controlling the volume and the tone quality of sounds at the seats in a vehicle. The display device is capable of displaying, on one display panel, a first image that can be observed from a first direction and a second image that can be observed from a second direction, is further capable of producing a first sound corresponding to the first image and a second sound corresponding to the second image, and includes a sound adjusting section which is capable of independently adjusting the first sound and the second sound. The invention further provides a method of adjusting sounds in the display device.

### BACKGROUND OF THE INVENTION

1. Field of the Invention

The present invention relates to a display device or a so-called multi-view display device which is equipped with an acoustic control unit for controlling the sound volume and/or the tone quality of sounds (acoustic information) produced at the seats of a moving body (e.g., vehicle) and is capable of displaying a plurality of images (or pictures) that can be separately observed from a plurality of directions simultaneously on the same display panel. The invention further relates to a method of adjusting sounds of the display device for realizing the adjustment of sound volume and/or tone quality of sounds produced at the seats of the moving body.

Here, the “sound volume” stands for the magnitude of a sound and the “tone quality” stands for a qualitative value of the sound such as reverberation characteristics (so-called sound field) determined by frequency characteristics of the sound and delay processing.

2. Description of the Related Art

A so-called multi-view display device has been realized, which is capable of offering separate images to the observers on the right and left sides through the same display panel. This multi-view display device enables the observers to observe separate images through their left eyes and right eyes from the left side and from the right side of the display panel; i.e., observers can watch three-dimensional images without really using spectacles for viewing three-dimensional images. Besides, separate images can be observed by a plurality of users having different viewing angles from the left side and the right side of the display panel. This permits application even to a device that enables different images to be simultaneously observed by a plurality of users. For example, when the above display device is installed in a vehicle, navigation information can be displayed on the display panel of the display device for a driver on the driver's seat while displaying TV images or DVD (digital video disk) images on the display panel for a passenger on the assistant driver's seat.

Concerning this multi-view display device, further, a system has been known, which permits the driver only to listen to a first sound (acoustic information) corresponding to the image observed on the side of the driver's seat and permits the passenger on the assistant driver's seat only to listen to a second sound (acoustic information) corresponding to the image observed on the side of the assistant driver's seat (see, for example, patent document No. 1 below).

Concerning the above multi-view display device, further, an output control device has been disclosed equipped with a function for suppressing the crosstalk that generates between the first sound heard on the side of the driver's seat and the second sound heard on the side of the assistant driver's seat (see, for example, patent document No. 2 below which was filed on Dec. 14, 2004 and is scheduled to be laid open in June, 2006). (1) Patent document No. 1: Japanese Unexamined Patent Publication (Kokai) No. 2003-137005 (2) Patent document No. 2: Japanese Patent Application No. 2004-361402

In the conventional multi-view display devices as disclosed in the patent documents No. 1 and No. 2 mentioned above, the driver only is permitted to watch and listen to the first sound corresponding to the image on the side of the driver's seat and the passenger on the assistant driver's seat only is permitted to watch and listen to the second sound corresponding to the image on the side of the assistant driver's seat, so that different images can be offered for the passengers on the their seats; i.e., depending on the driver's seat and the assistant driver's seat. However, the conventional multi-view display devices are not equipped with a function for adjusting the tone quality and sound volume independently concerning sounds that are heard on the seats such as the driver's seat and the assistant driver's seat, and are accompanied by a problem in which it is impossible to suitably control the tone quality and sound volume to meet for the seats.

### SUMMARY OF THE INVENTION

The present invention was accomplished in view of the above problem and has an object of providing a multi-view display device equipped with an acoustic control unit for suitably controlling the sound volume and/or the tone quality of sounds produced at the seats in a moving body, and a method of adjusting sounds for realizing a suitable adjustment of the sound volume/and or the tone quality of sounds produced at the seat in the moving body.

In order to attain the above object, a display device according to the present invention comprises:

a display section which displays individual images in a plurality of viewing ranges on a common screen;

a sound producing section which produces sounds each corresponding to the individual images displayed in each of the viewing ranges; and

a sound adjusting section which independently adjusts the sounds.

Preferably, in the display device of the present invention, the sound adjusting section applies a sound adjusting state for one of the viewing ranges as a sound adjusting state for another of the viewing ranges.

Further, preferably, in the display device of the present invention, the sound adjusting section interchanges a sound adjusting state for one of the viewing ranges and a sound adjusting state for another of the viewing ranges.

Further, preferably, the display device of the present invention further comprises a preset data storing section which stores sound setting values each corresponding to the one of the viewing ranges, wherein said sound adjusting section independently adjusts the each of the sounds on the basis of the sound setting values.

Further, preferably, the display device of the present invention further comprises a preset data registering section which stores sound setting values each corresponding to one of the viewing ranges in response to a user's operation, wherein said sound adjusting section independently adjusts each of the sounds on the basis of the sound setting values.

Further, preferably, in the display device of the present invention, the sound adjusting section has a common mode in which the sounds are commonly adjusted and a individual mode in which each of the sounds is adjusted independently.

Further, preferably, the display device of the present invention further comprises a common sensor which detects a state of a surrounding environment in the viewing ranges, wherein the sound adjusting section adjusts the sounds on the basis of the detected state.

Further, preferably, the display device of the present invention further comprises a plurality of sensors each of which detects a state of a surrounding environment in corresponding one of the viewing ranges, wherein the sound adjusting section independently adjusts corresponding one of the sounds on the basis of the detected state.

Further, preferably, in the display device of the present invention, the sound producing section produces a predetermined sound while the sound is adjusted.

Further, preferably, in the display device of the present invention, the sound producing section allows an output of one of the sounds to be adjusted and turns off the other sound while one of the sounds is adjusted.

Further, preferably, the display device of the present invention further comprises an initial setting value storage section which stores a plurality of initial setting values each corresponding to one of the viewing ranges, wherein the sound adjusting section adjusts the sounds on the basis of the initial setting values when the display device is turned on.

Further, preferably, the display device of the present invention further comprises a frequency storage section which store each frequency of a sound adjustment in each of the viewing ranges, wherein the sound adjusting section adjusts each of the sounds on the basis of the stored frequencies.

Further, preferably, in the display device of the present invention, sound setting values are stored in the initial setting value storage section before the display device is turned off.

Further, preferably, in the display device of the present invention, the sound adjusting section adjusts a volume of each of the sounds.

Further, preferably, in the display device of the present invention, the sound adjusting section adjusts frequency characteristics of each of the sounds.

Further, preferably, in the display device of the present invention, a maximum level of the volume of the sounds is limited at a predetermined level.

On the other hand, a method of adjusting sounds of a display device comprises the steps of:

displaying images individually in a plurality of viewing ranges on a common screen;

producing sounds each corresponding to the individual images displayed in each of the viewing range; and

adjusting each of the sounds independently.

Preferably, the method of adjusting sounds of the display device of the present invention further comprises the step of storing sound setting values each corresponding to the viewing ranges, wherein each of the sounds is adjusted on the basis of the sound setting values.

According to the present invention, the sound volume and tone quality (intensity and pitch of sound) of a first sound (acoustic information) produced at, for example, the driver's seat can be adjusted independently of the adjustment of the sound volume and tone quality of a second sound produced at the assistant driver's seat, making it possible to adjust the sound volume and tone quality to be suited for the seats, i.e., for the driver's seat and the assistant driver's seat.

According to the present invention, the image quality of a first image observed from the driver's seat can be adjusted independently of the adjustment of the image quality of a second image observed from the assistant driver's seat on a display screen of a display unit. Besides, the sound volume and tone quality of the first sound corresponding to the first image produced at the driver's seat can be adjusted independently of the sound volume and tone quality of the second sound corresponding to the second image produced at the assistant driver's seat. Therefore, the display screen can be adjusted to suit for the seats, i.e., to suit for the driver's seat and the assistant driver's seat and, besides, the sound volume and tone quality can be adjusted to suit for the seats.

According to the present invention, further, the state of adjusting the sound volume and tone quality of either the first sound or the second sound can be changed over to the state of adjusting the sound volume and tone quality of the other sound through a simple operation of a sound adjust copy operating section such as a select button or the like. Therefore, a driver or a passenger who changes the seat is allowed to take over the sound volume and tone quality which he (or she) likes.

According to the present invention, further, the states of adjusting the sound volume and tone quality at a first place and a second place can be exchanged through a simple operation of a sound adjust exchange operating section. When a different person is going to drive the vehicle, i.e., when a person changes his seat from, for example, the driver's seat to the assistant driver's seat, he (or she) can take over the sound volume and tone quality which he (or she) likes.

According to the present invention, further, it is allowed to select a desired setpoint for every sound out of a plurality of setpoints of sound volume and tone quality of the first and second sounds that have been held in advance due to a preset function. Therefore, the sound volume and the tone quality can be easily adjusted at the first place and at the second place.

According to the present invention, further, the sound volume and the tone quality of the first sound and the second sound can be adjusted together in the same direction; i.e., the sound volume and the tone quality can be adjusted at one time to meet a change in the surrounding environment, etc., (e.g., change in the surrounding noise level).

According to the present invention, further, the sound volume and the tone quality of the first sound and the second sound can be adjusted together in the same direction depending upon the result detected by a surrounding environment sensor (e.g., noise sensor or the like); i.e., the sound volume and the tone quality can be automatically adjusted at one time to meet a change in the surrounding environment.

According to the present invention, further, a plurality of surrounding environment sensors (e.g., window open/close sensors or the like) are provided independently for the first place and the second place, and the sound volume and the tone quality can be independently adjusted for the seats, i.e., for the driver's seat and for the assistant driver's seat depending upon the results detected by the plurality of surrounding environment sensors. Therefore, the sound volume and the tone quality can be automatically and suitably adjusted depending upon changes in the environment which is not the same for the driver's seat and the assistant driver's seat.

Further, the invention produces a sound for adjusting the sound volume and the tone pitch of at least either the first sound or the second sound, facilitating the adjustment of sound volume and tone quality at the seats, i.e., at the driver's seat and the assistant driver's seat.

According to the present invention, further, the sound volumes and the tone qualities of the first and second sounds are set by reading the state of adjusting the sound volume and the tone quality of the first sound and the state of adjusting the sound volume and the tone quality of the second sound (also called “last memory”) stored just before starting the display device. This makes it possible to select the state of adjusting the sound volume and the tone quality that are highly probable to be continuously used and, hence, to omit the operation for adjusting the sound volume and the tone quality.

According to the present invention, further, the sound volumes and the tone qualities of the first and second sounds are set by reading out the highest value of setpoint frequency for each of the seats at the start of the display device, making it possible to select at the start the state of adjusting the sound volume and the tone quality which are most probable to be used.

According to the present invention, further, an upper limit for adjusting the sound volume is set to at least either the first sound or the second sound, so that the sound of TV or DVD watched and heard on one seat side (particularly, on the side of the assistant driver's seat) will not interfere the sound heard by the passenger on the other seat side (particularly, on the side of the driver's seat). Further, if upper limits of sound volume are set independently for the first sound and the second sound, the sound heard on each side of the seat is suppressed from offending the passenger on the other side of the seat.

According to the present invention, further, it is allowed to adjust at one place the sound volume and the tone quality of the sound produced at the other place making it possible to easily avoid the effect on the passenger at one place caused by the sound produced at the other place. Further, even when the passenger at the other place does not know how to adjust the sound volume and the tone quality of the sound, the passenger at one place is allowed to adjust the sound volume and tone quality of the sound of the other place on his behalf.

According to the present invention, further, the sound volume and the tone quality of the first sound produced at the driver's seat can be adjusted independently of the adjustment of the sound volume and the tone quality of the second sound produced at the assistant driver's seat. This makes it possible to adjust the sound volumes and tone qualities suited for the seats, i.e., for the driver's seat and the assistant driver's seat.

### BRIEF DESCRIPTION OF THE DRAWINGS

The above object and features of the present invention will be more apparent from the following description of some preferred embodiments with reference to the accompanying drawings, wherein:

FIG. 1 is a diagram schematically illustrating a display device according to the present invention;

FIG. 2 is a perspective view illustrating an example of mounting the display device;

FIG. 3 is a schematic view illustrating the structure of a display unit 7 in cross section;

FIG. 4 is a schematic view illustrating the structure of a liquid crystal display panel 100 as viewed from the front;

FIG. 5 is a circuit diagram schematically illustrating a TFT substrate 104;

FIG. 6 is a block diagram schematically illustrating the display device according to the present invention;

FIG. 7 is a block diagram schematically illustrating an image output unit 211;

FIG. 8 is a block diagram schematically illustrating a control unit 200;

FIG. 9 is a block diagram schematically illustrating a memory 218;

FIG. 10 is a block diagram illustrating the constitution of a multi-view display device according to a first embodiment of the present invention;

FIG. 11 is a view schematically illustrating the sectional shape of a display unit 10a in FIG. 10;

FIG. 12 is a block diagram illustrating the multi-view display device according to a second embodiment of the present invention;

FIG. 13 is a view schematically illustrating the sectional shape of a display unit 10a in FIG. 12;

FIG. 14 is a flowchart (part 1) for illustrating a sound adjust processing in an acoustic control unit 1a;

FIG. 15 is a flowchart (part 2) for illustrating the sound adjust processing in the acoustic control unit 1a;

FIG. 16 is a diagram illustrating examples of display while the sound is being adjusted;

FIG. 17 is a flowchart illustrating a modified example (part 1) of the sound adjust processing in the acoustic control unit la shown in FIGS. 14 and 15;

FIG. 18 is a flowchart illustrating a modified example (part 2) of the sound adjust processing in the acoustic control unit 1a shown in FIGS. 14 and 15;

FIG. 19 is a flowchart illustrating a modified example (part 3) of the sound adjust processing in the acoustic control unit 1a shown in FIGS. 14 and 15;

FIG. 20 is a flowchart illustrating a modified example (part 4) of the sound adjust processing in the acoustic control unit 1a shown in FIGS. 14 and 15;

FIG. 21 is a flowchart illustrating a modified example (part 5) of the sound adjust processing in the acoustic control unit 1a shown in FIGS. 14 and 15;

FIG. 22 is a flowchart for illustrating a sound adjust processing depending upon a change in the environment;

FIG. 23 is a flowchart for illustrating the sound adjust processing at the start; and

FIG. 24 is a flowchart for illustrating a storage processing for storing sound adjust setpoints.

### DESCRIPTION OF THE PREFERRED EMBODIMENTS

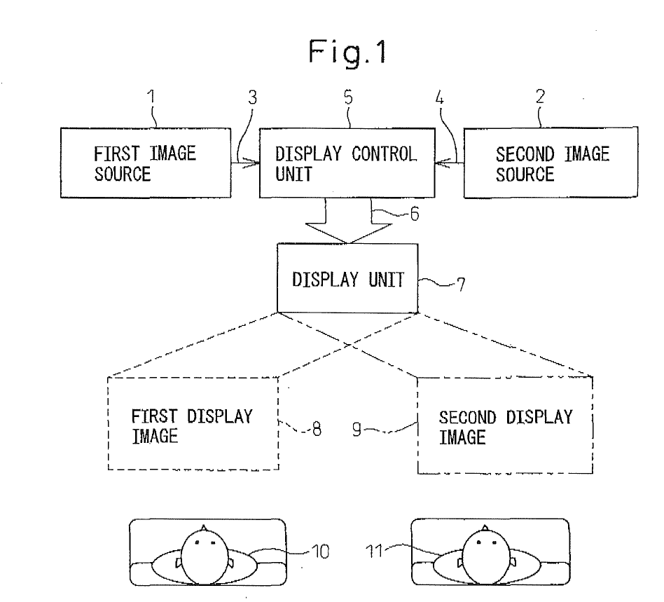

Embodiments of the invention will now be described with reference to the accompanying drawings (FIGS. 1 to 24). Here, however, it should be noted that the technical scope of the present invention is not limited by the embodiments only but also encompasses the invention recited in claims and even equivalents thereof.

Described below, first, are the schematic constitution of a display device that serves as a prerequisite of the embodiments of the invention and the operation thereof.

FIG. 1 is a diagram schematically illustrating a display device according to the present invention. Hereinafter, the constituent elements which are the same as those described above are denoted by the same reference numerals.

In the drawing, reference numeral 1 denotes a first image source, 2 denotes a second image source, 3 denotes a first image data from the first image source, 4 denotes a second image data from the second image source, 5 denotes a display control unit, 6 denotes a display data, 7 denotes a display unit (e.g., liquid crystal display panel or the like), 8 denotes a first display picture based on the first image data 3 from the first image source 1, reference numeral 9 denotes a second display image based on the second image data 4 from the second image source 2, reference numeral 10 denotes an observer (user) positioned on the left side of the display unit 7, and reference numeral 11 denotes an observer (user) positioned on the right side of the display unit 7.

In the schematic diagram of FIG. 1, the observer 10 is allowed to watch the first display image 8 while the observer 11 is allowed to view the second display image 9 substantially simultaneously depending upon the positions of the observers 10 and 11 relative to the display unit 7 or, in other words, depending upon their visual field angles relative to the display unit 7. Besides, the display images 8 and 9 can be watched over the whole display surface of the display unit 7. In FIG. 1, the first image source 1 is, for example, a DVD player or a TV receiver. The first image data includes a movie image or a received image which is outputted from the DVD player or the TV receiver. The second image source 2 is, for example, a car navigation device. The second image data includes a map or a route guide image which is outputted from the car navigation device. The first image data 3 and the second image data 4 thereof are fed to the display control unit 5 in which they are so processed as can be displayed on the display unit 7 substantially simultaneously.

The display unit 7 fed with the display data from the display control unit 5 is constituted by a liquid crystal display panel or the like equipped with a parallax barrier that will be described later. A half of the total pixels of the display unit 7 in the transverse direction is used for displaying the first display image 8 based on the first image source 1, and another half of the pixels is used for displaying the second display image 9 based on the second image source 2. Only those pixels corresponding to the first display image 8 can be seen by the observer 10 on the left side of the display unit 7, but the second display image 9 cannot be substantially seen being interrupted by the parallax barrier formed on the surface of the display unit 7. On the other hand, only those pixels corresponding to the second display image 9 can be seen by the observer 11 on the right side of the display unit 7, hut the first display image 8 cannot be substantially seen being interrupted by the parallax barrier.

A single screen of the above constitution makes it possible to offer different kinds of information and contents to the users on the right and left sides. If the first image source 1 is the same as the second image source 2, the users on the right and left sides can share the same image in a customary manner, as a matter of course.

As described above, attention should be given to that the display device according to the present invention has only one screen for displaying a plurality of images; i.e., a plurality of images (two kinds of images in FIG. 1) which can be independently adjusted for their image qualities are simultaneously displayed on one screen.

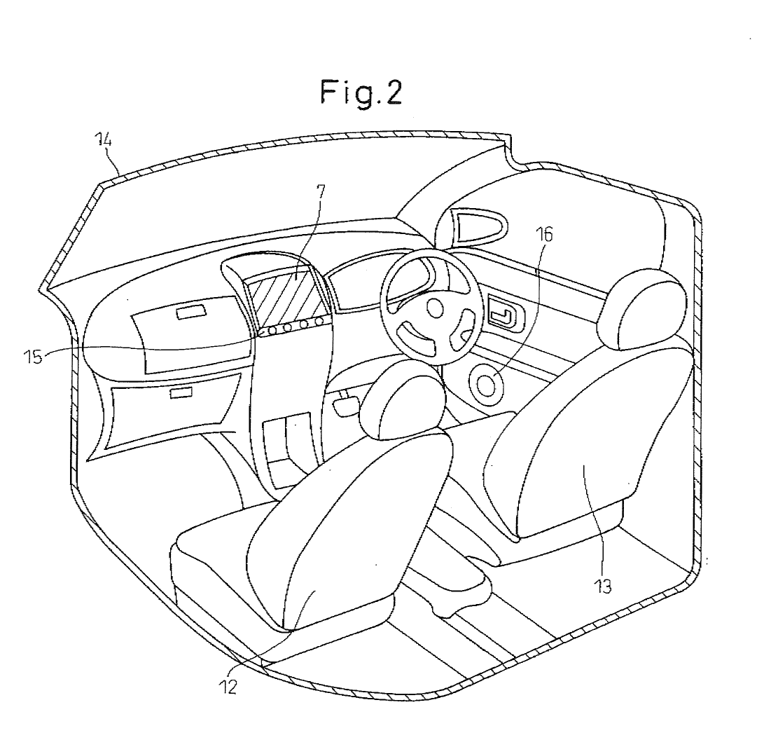

FIG. 2 is a perspective view illustrating an example of mounting the multi-view display device of the present invention on a vehicle, wherein reference numeral 12 denotes an assistant driver's seat, 13 denotes a driver's seat, 14 denotes a windshield, 15 denotes an operating unit and 16 denotes speakers.

Referring, for example, to FIG. 2, the display unit 7 of the multi-view display device of FIG. 1 is arranged in a dashboard portion nearly at the center between the driver's seat 13 and the assistant driver's seat 12. A variety of operations for the multi-view display device are executed by using a touch panel (not shown) or an operating unit 15 integrally formed on the surface of the display unit 7, or by using an infrared-ray or radio remote controller (not shown). Speakers 16 are arranged in the doors of the vehicle to produce sounds and alarm sounds which are related to the display images.

The observer 11 of FIG. 1 sits on the driver's seat 13, and the observer 10 sits on the assistant driver's seat 12. The image on the display unit 7 that can be seen from the first viewing direction (from the side of the driver's seat) is, for example, an image of a map or the like of a car navigation device, and an image that can be seen from a second viewing direction (from the side of the assistant driver's seat) substantially simultaneously is, for example, a TV received image or a movie image of DVD. Therefore, the passenger on the assistant driver's seat 12 can enjoy watching the TV or DVD while the driver on the driver's seat 13 is assisted for his driving by the car navigation device. Besides, each image is displayed over the whole screen of, for example, 7 inches. Unlike the conventional multi-window display, therefore, the image size does not become small. Namely, the driver and the passenger are furnished with information and contents which are best suited for them as if there are provided independent and dedicated displays.

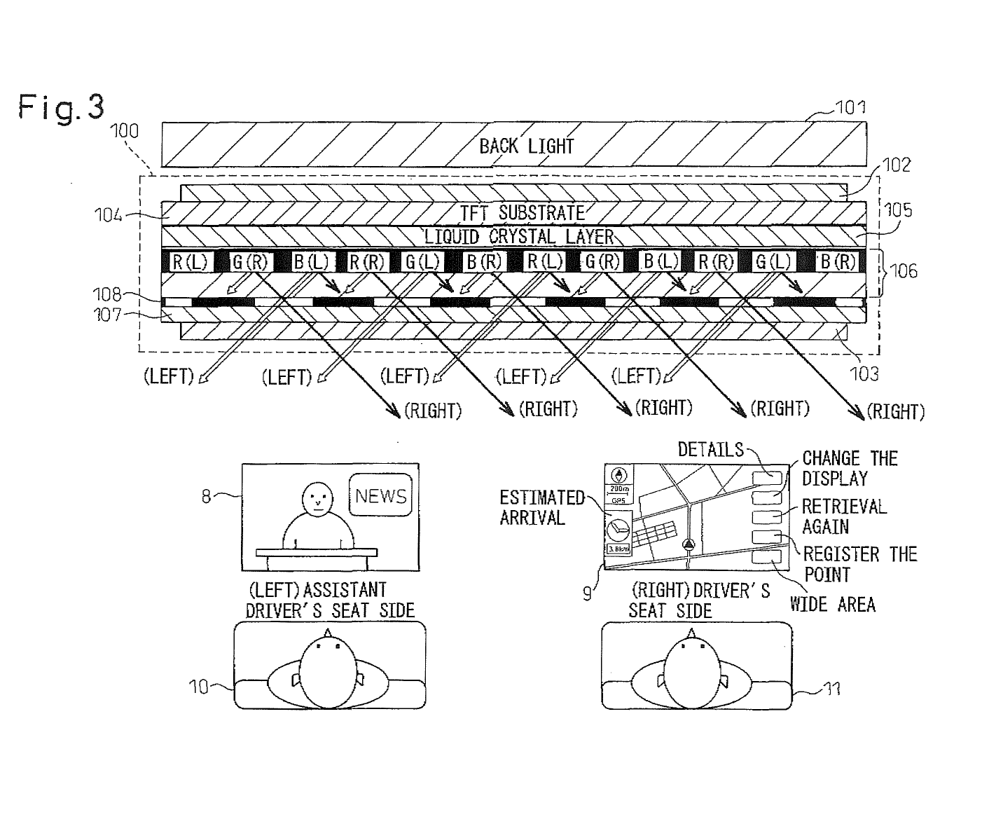

FIG. 3 is a schematic view illustrating the structure of the display unit 7 in cross section, wherein reference numeral 100 denotes a liquid crystal display panel, 101 denotes a back light, 102 denotes a polarizing plate installed on the liquid crystal display panel on the side of the back light, 103 denotes a polarizing plate arranged on the front surface of the liquid crystal display panel in the light-emitting direction, 104 denotes a TFT (thin film transistor) substrate, 105 denotes a liquid crystal layer, 106 denotes color filter substrates, 107 denotes a glass substrate, and 108 denotes a parallax barrier. The liquid crystal display panel 100 is constituted by a pair of substrates holding the liquid crystal layer 105 between the TFT substrate 104 and the color filter substrates 106 arranged facing thereto, and the parallax barrier 108 and the glass substrate 107 which are arranged on the front surface in the light-emitting direction sandwiched between the two pieces of polarizing plates 102 and 103. The liquid crystal display panel 100 is arranged being slightly separated away from the back light 101. Thus, by virtue of the above constitution, the liquid crystal display panel 100 can have pixels of RGB colors (three primary colors).

The pixels of the liquid crystal display panel 100 are divided into those for display on the left side (assistant driver's seat side) and for display on the right side (driver's seat side), and are controlled for display. The pixels for display on the left side (assistant driver's seat side) are prevented by the parallax barrier 108 from offering display to the right side (driver's seat side), and can be seen only from the left side (assistant driver's seat side). On the other hand, the pixels for display on the right side (driver's seat side) are prevented by the parallax barrier 108 from offering display to the left side (assistant driver's seat side), and can be seen only from the right side (driver's seat side). Thus, different displays can be offered to the driver and to the passenger. That is, the driver is furnished with map information of navigation while the passenger can watch a movie of DVD. Upon changing the parallax barrier 108 and the constitution of pixels of the liquid crystal display panel, further, it becomes possible to fabricate a constitution that displays different images in a plurality of directions such as in three directions. Further, the parallax barrier itself may be constituted by using a liquid crystal shutter that can be electrically driven to vary the visual field angle.

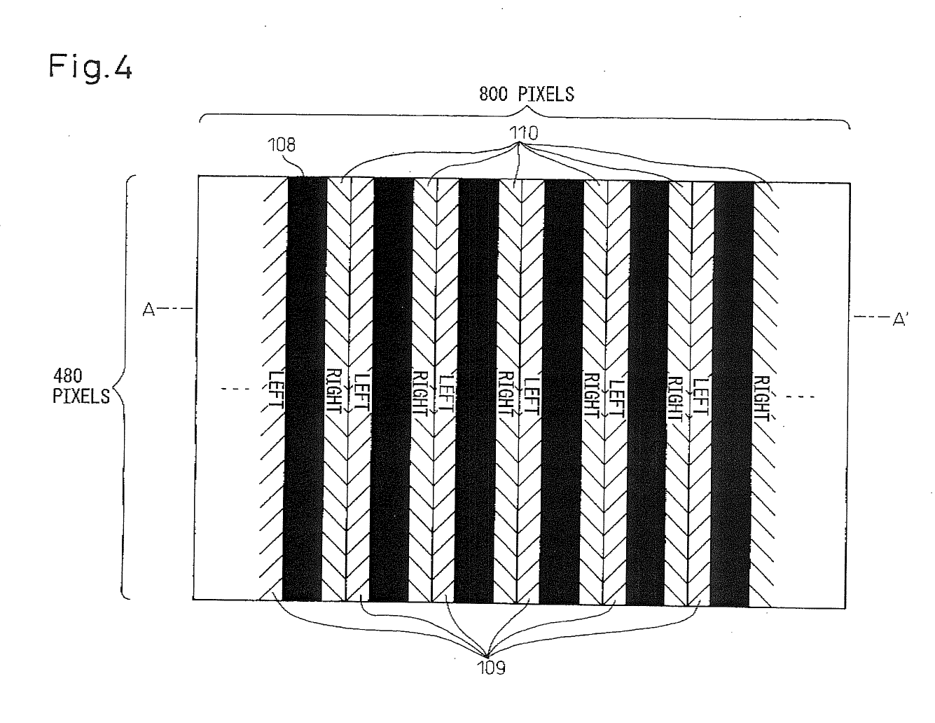

FIG. 4 is a schematic view illustrating the structure of the liquid crystal display panel as viewed from the front, and FIG. 3 is a sectional view along A-A of FIG. 4. In FIG. 4, reference numeral 109 denotes pixels for display on the left side (assistant driver's seat side), and 110 denotes pixels for display on the right side (driver's seat side). FIGS. 3 and 4 illustrate a portion of the liquid crystal display panel 100 in which 800 pixels are arranged in the transverse direction and 480 pixels are arranged in the longitudinal direction. The pixels 109 for display on the left side (assistant driver's seat side) and the pixels 110 for display on the right side (driver's seat side) are grouped in the longitudinal direction, and are alternately arranged. The parallax barriers 108 are arranged maintaining a distance in the transverse direction and remain uniform in the longitudinal direction. Therefore, if the display panel is viewed from the left side, the parallax barriers 108 conceal the pixels 110 for the right side, and the pixels 109 for the left side can be seen. Similarly, if viewed from the right side, the parallax barriers 108 conceal the pixels 109 for the left side, and the pixels 110 for the right side can be seen. Near the surface, further, both the pixels 109 for the left side and the pixels 110 for the right side can be seen and, hence, the display image on the left side and the display image on the right side can be seen being substantially overlapped one upon the other. Here, the pixels 109 for the left side and the pixels 110 for the right side alternately arranged in FIG. 4 have colors RGB as shown in FIG. 3. However, each group may be constituted by a single color in the longitudinal direction like column R, column G or column B, or may be constituted as a column of a mixture of RGB.

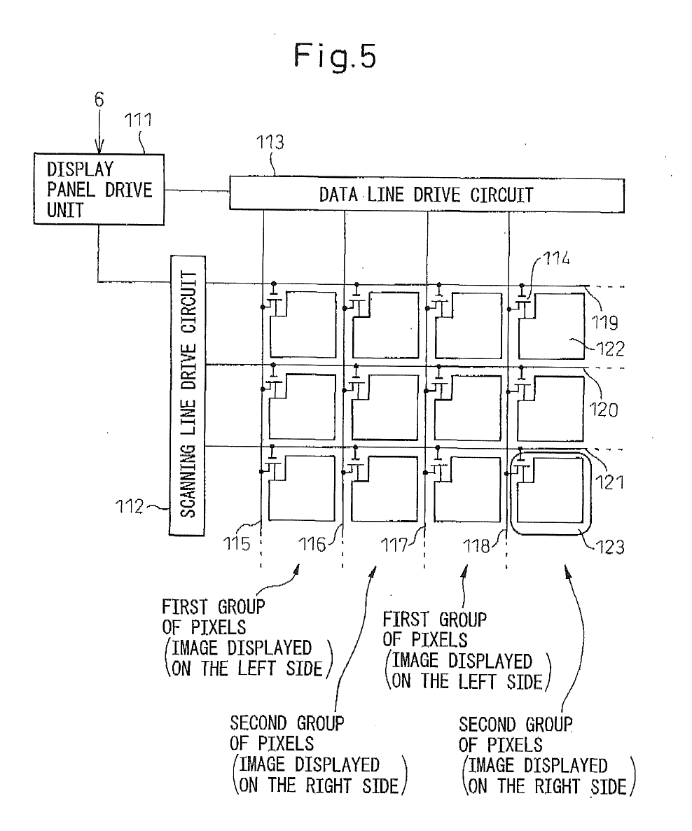

FIGS. 5 is a circuit diagram schematically illustrating the TFT substrate 104, and wherein reference numeral 111 denotes a display panel drive unit, 112 denotes a scanning line drive circuit, 113 denotes a data line drive circuit, 114 denotes TFT elements, 115 to 118 denote data lines, 119 to 121 denote scanning lines, 122 denotes pixel electrodes, and 123 denotes sub-pixels.

Referring to FIG. 5, the sub-pixels 123 are formed in a plural number with each region surrounded by the data lines 115 to 118 and by the scanning lines 119 to 121 as a unit. Each sub-pixel includes a pixel electrode 122 for applying a voltage to the liquid crystal layer 105 and a TFT element 114 for switch-controlling the pixel electrode 122. The display panel drive unit 111 controls the timings for driving the scanning line drive circuit 112 and the data line drive circuit 113. The scanning line drive circuit 112 selectively scans the TFT elements 114, and the data line drive circuit 113 controls the voltage applied to the pixel electrodes 122.

Based on the synthetic data of the first picture data and the second image data or based on the first and second image data, the plurality of sub-pixels transmit the first pixel data (for displaying an image on the left side) to the data lines 115 and 117, and transmit the second pixel data (for displaying an image on the right side) to the data lines 116 and 118, to thereby form a first group of pixels for displaying the first image and a second group of pixels for displaying the second image.

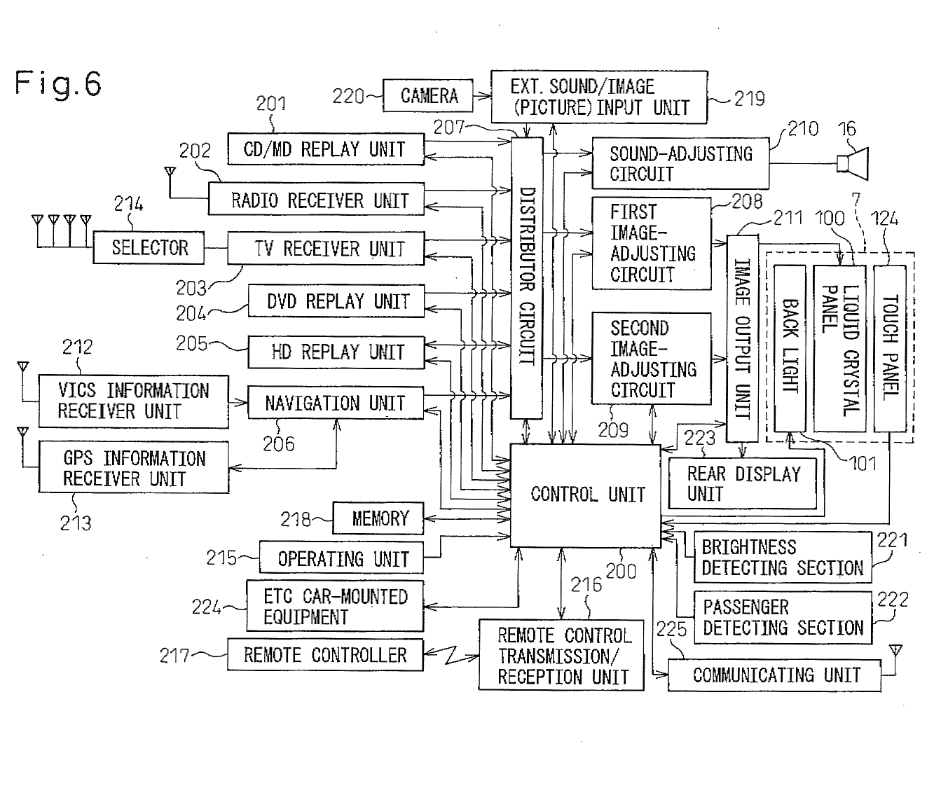

FIG. 6 is a block diagram schematically illustrating the display device according to the present invention which is applied to a so-called AVN (audio visual navigation) composite device. In FIG. 6, reference numeral 124 denotes a touch panel, 200 denotes a control unit, 201 denotes a CD/MD replay unit, 202 denotes a radio receiver unit, 203 denotes a TV receiver unit, 204 denotes a DVD replay unit, 205 denotes a hard disk (HD) replay unit, 206 denotes a navigation unit, 207 denotes a distributor circuit, 208 denotes a first image-adjusting circuit, 209 denotes a second image-adjusting circuit, 210 denotes a sound-adjusting circuit, 211 denotes an image output unit, 212 denotes a VICS information receiver unit, 213 denotes a GPS information receiver unit, 214 denotes a selector, 215 denotes an operating unit, 216 denotes a remote control transmission/reception unit, 217 denotes a remote controller, 218 denotes a memory, 219 denotes an external sound/image (picture) input unit, 220 denotes a camera, 221 denotes a brightness detecting unit, 222 denotes a passenger detecting unit, 223 denotes a rear display unit, 224 denotes an ETC car-mounted equipment, and 225 denotes a communicating unit.

The display unit 7 is constituted by the touch panel 124, liquid crystal display panel 100 and back light 101. As described above, the liquid crystal display panel 100 of the display unit 7 is capable of substantially simultaneously displaying an image which is seen from the first viewing direction or from the side of the driver's seat and an image which is seen from the second viewing direction or from the side of the assistant driver's seat. As the display unit 7, there can be used a flat panel display other than the liquid crystal display panel, such as an organic EL display panel, a plasma display panel, or a cold-cathode flat panel display.

The image data and the sound data from various sources (CD/MD replay unit 201, radio receiver unit 202, TV receiver unit 203, DVD replay unit 204, HD replay unit 205 and navigation unit 206) are distributed, via the distributor circuit 207, to the first image-adjusting circuit 208 when they are the image data of the image source specified to be for the left side and to the second image-adjusting circuit 209 when they are the image data of the image source specified to be for the right side, i.e., the image data are distributed to the first image-adjusting circuit 208 and to the second image-adjusting circuit 209, and the sound data are distributed to the sound-adjusting circuit 210. The first and second image-adjusting circuits 208 and 209 adjust the brightness of the image, color tone and contrast, and the thus adjusted images are displayed on the display unit 7 through the image output unit 211. The sound-adjusting circuit 210 adjusts the distribution, sound volume and tone quality to each of the speakers, and the adjusted sound is output from the speakers 16.

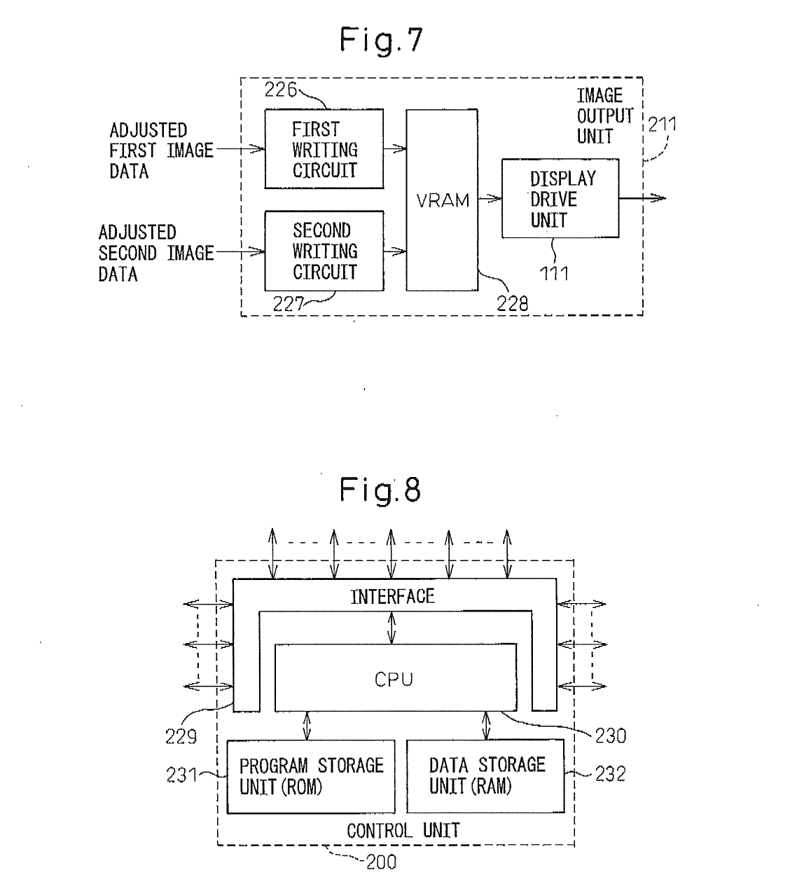

FIG. 7 is a block diagram schematically illustrating the image output unit 211, wherein reference numeral 226 denotes a first writing circuit, 227 denotes a second writing circuit, and 228 denotes a VRAM (video random access memory: frame buffer-only RAM of graphics display),

As shown in, for example, FIG. 7, the image output unit 211 includes the first writing circuit 226, second writing circuit 227, VRAM (video RAM) 226 and display drive unit 111. For example, the first writing circuit 226 writes, into the corresponding region in the VRAM 228, the image data corresponding to the columns of odd numbers (i.e., image data for the first display image 8 in FIG. 1) among the image data adjusted by the first image-adjusting circuit 208, and the second writing circuit 227 writes, into the corresponding region in the VRAM 228, the image data corresponding to the columns of even numbers (i.e., image data for the first display image 9 in FIG. 1) among the image data adjusted by the second image-adjusting circuit 209. The display drive unit 111 is a circuit for driving the liquid crystal display panel 100, and drives the corresponding pixels in the liquid crystal display panel 100 based on the image data (synthetic data of the first image data and the second image data) held in the VRAM 228. Into the VRAM 228 are written the image data obtained by synthesizing the first image data and the second image data so as to be corresponded to the image for multi-view display. Therefore, only one drive circuit may be employed, and its operation is the same as the operation of a drive circuit in an ordinary liquid crystal display device As another constitution, further, there can be contrived to use a first display panel drive circuit and a second display panel drive circuit for driving the corresponding pixels in the liquid crystal display panel based on the respective image data without synthesizing the first image data and the second image data together.

Various sources shown in FIG. 6 will now be described. When the HD replay unit 205 is selected, music data such as MP3 file, image data such as JPEG file, that are stored in the hard disk (HD), and menu display and image data for selecting the music data and the image data that are to be replayed, can be displayed on the display unit 7.

The navigation unit 206 includes a map data information unit storing map information used for the navigation, obtains information from the VICS information receiver unit 212 and the GPS information receiver unit 213, forms an image for navigation operation, and outputs it. The TV receiver unit 203 receives, from the antenna, analog TV broadcast waves and digital TV broadcast waves through the selector 214, and outputs the image included therein.

Further, the image (picture) from, for example, the camera 220 for monitoring the rear view connected to the external sound/image(picture) input unit 219 may be displayed on the display unit 7. In addition to the camera 220 for monitoring the rear view, a video camera and a game machine or the like may be connected to the external sound/image(picture) input unit 219.

FIG. 8 is a block diagram schematically illustrating the control unit 200, wherein reference numeral 229 denotes an interface, 230 denotes a CPU, 231 denotes a storage unit, and 232 denotes a data storage unit.

The control unit 200 controls the distributor circuit 207 and various sources, and has the selected two sources or one source displayed. The control unit 200 further displays, on the display unit 7, an operation menu for controlling various sources. Here, as shown in FIG. 8, the control unit 200 is constituted by a microprocessor or the like and includes the CPU 230 which generally controls various unit and circuits in the display device via the interface 229. The CPU 230 is provided with a program storage unit 231 comprising a ROM (read-only memory) for storing various programs necessary for operating the display device and a data storage unit 232 comprising a RAM (random access memory) for holding various data. The ROM and RAM may be those incorporated in the CPU or those provided on the outer side thereof. Further, the ROM may be an electrically rewritable nonvolatile memory such as a flush memory.

The user may operate the above-mentioned various sources by using a touch panel 124 attached to the surface of the display unit 7, by using the switches provided in the periphery of the display unit 7, or by effecting the input operation or selection operation such as sound recognition through an operating unit 215. Alternatively, the input or selection operation may be executed by using the remote controller 217 via the remote control transmission/reception unit 216. The control unit 200 executes the control operation inclusive of the control of various sources according to the operation through the touch panel 14 and the operating unit 215. Further, the control unit 200 controls the sound volumes of the speakers 16 provided in a plural number in the vehicle as shown in FIG. 2 by using the sound-adjusting circuit 210. The control unit 200 further works to store various setpoint data such as the image quality setpoint data, program and vehicle data in the memory 218.

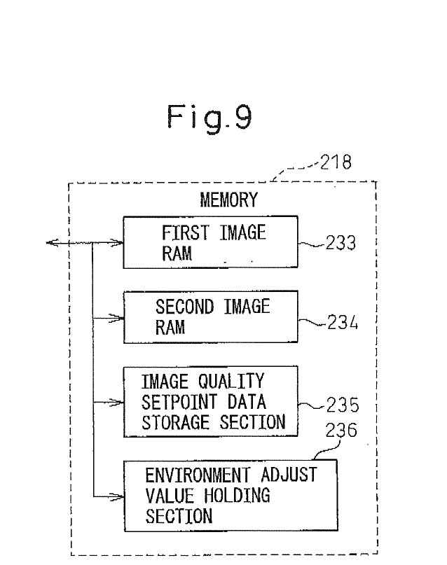

FIG. 9 is a block diagram schematically illustrating the memory 218, wherein reference numeral 233 denotes a first image RAM, 234 denotes a second image RAM, 235 denotes an image quality setpoint data storage section, and 236 denotes a environment adjust value holding section. Concrete constitutions of the first image RAM, second image RAM, image quality setpoint data storage section and environment adjust value holding section will be described later with reference to FIG. 17.

As shown in, for example, FIG. 9, the memory 218 includes the first image RAM 233 and the second image RAM 234 into which can be written adjust values of image qualities of the first image and the second image set by the user. To adjust the image qualities of the first image and the second image, there is further provided the image quality setpoint data storage section 235 storing image quality adjust values of a plurality of steps as preset values for adjusting image qualities that can be read out. There is further provided the environment adjust value holding section 236 holding adjust values for adjusting the qualities of the first image and the second image for the surrounding environment in order to adjust the image quality in response to a change in the surrounding environment such as a change in the brightness on the outside of the vehicle. Here, the image quality setpoint data storage section 235 and the environment adjust value holding section 236 are constituted by electrically rewritable nonvolatile memories such as flush memories or volatile memories backed up with a battery.

The control unit 200 may vary the position of the sound based on the data detected by the brightness detecting unit 221 (e.g., light switch or optical sensor of the vehicle) or detected by the passenger detecting unit 222 (e.g., pressure sensors provided in the driver's seat and in the assistant driver's seat).

Reference numeral 223 denotes the rear display unit provided for the rear seat of the vehicle, and displays the same image as the one displayed on the display unit 7, or displays either the image for the driver's seat or the image for the assistant driver's seat through the image output unit 211.

The control unit 200 displays the fees from the ETC car-mounted equipment 250. The control unit 200 may further control the communicating unit 225 that wirelessly connects to a cell phone to display information related thereto.

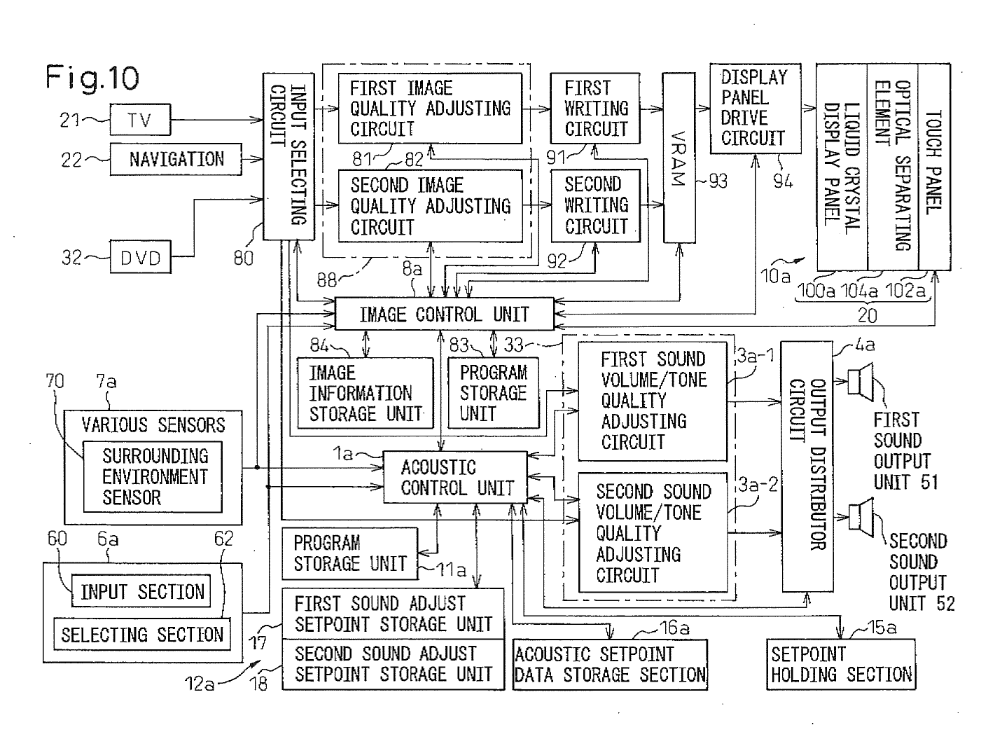

Next, preferred embodiments of the invention will be described with reference to the accompanying drawings (FIGS. 10 to 24).

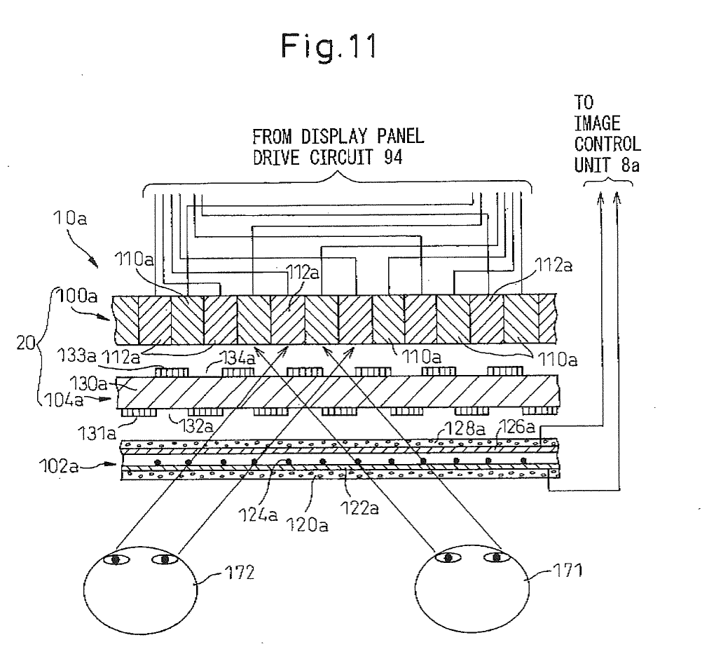

FIG. 10 is a block diagram illustrating the constitution of the multi-view display device according to a first embodiment of the present invention, and FIG. 11 is a view schematically illustrating the sectional shape of a display unit 10a in FIG. 10.

Schematically illustrated here is the constitution of the car-mounted multi-view display device in which two kinds of independent images are displayed on the screen of the same liquid crystal display panel 100a by writing two kinds of image data from the image/acoustic source and of which the image qualities have been separately adjusted into the VRAM (video random access memory: frame buffer-only RAM of graphics display) 93.

The multi-view display device of FIG. 10 is provided with a display unit 10a for providing a multi-view display for the driver's seat and the assistant driver's seat of the vehicle. The same multi-view display panel 20 of this display unit 10a displays a first image that can be observed from a first direction such as from the driver's seat and a second image that can be observed from a second direction such as from the assistant driver's seat.

The user (e.g., driver) on the right side of the multi-view display panel 20 observes the first image, and the user (e.g., assistant driver) on the left side observes the second image. The second image is not observed by the user on the right side while the first image is not observed by the user on the left side. Therefore, the user on the right side is allowed to watch the image which he (or she) likes without caring about the eyes of the user on the left side, while the user on the left side is allowed to watch the image which he (or she) likes without caring about the eyes of the user on the right side.

Further, the display unit 10a of FIG. 10 is of a structure in which an optical separating element 104a is provided on the front surface side of the liquid crystal display panel 100a to form the multi-view display panel 20, and a touch panel 102a is formed on the front surface thereof. In principle, there can be used a display device such as a CRT (cathode ray tube) or a plasma display panel in addition to the liquid crystal display panel 100a. The optical separating element 104a, on the other hand, may be constituted by a liquid crystal shutter to work actively (e.g., to work as a variable shutter).

Referring to FIG. 11, the touch panel 102a is constituted by a pair of transparent insulating substrates 120a and 128a having flexibility, transparent electrodes 122a and 126a formed on the above pair of transparent insulating substrates, and dot spacers 124a arranged like a matrix on the transparent electrodes. When the user depresses the transparent insulating substrate 120a causing the dot spacer 124a to come in contact with the transparent electrode 126a, the position of the contact point is detected by the measurement of electric resistance, and input information is read by the image control unit 8a in FIG. 10. The touch panel 102a is not limited to the one of the above constitution only but may be the one of any other system.

The liquid crystal display panel 100a of FIG. 11 is constituted by liquid crystal display elements and is divided into a plurality of belt-like display regions in the longitudinal direction, alternately forming first display regions 110a corresponding to the first image and second display regions 112a corresponding to the second image. The multi-view display panel 20 is formed by arranging the optical separation elements 104a on the front surface side of the liquid crystal display panel 100a of FIG. 11 as described above. The display elements of the liquid crystal display panel 100a are driven and controlled by the display panel drive circuit 94.

The optical separating element 104a has a function for offering a multi-view display by separating the first image observed from the driver's seat and the second image observed from the assistant driver's seat from each other at a predetermined visual field angle, and has a transparent cover (or a transparent insulating substrate) 130a formed by using a polycarbonate or the like. A plurality of light-shielding unit 131a, 133a are alternately formed on the front and back surfaces of the transparent cover 130a and, as a result, a plurality of light-transmitting slit unit 132a, 134a are alternately formed. In FIG. 11, the plurality of light-shielding unit and the plurality of light-transmitting slit unit are formed on the front and back surfaces of the transparent cover 130a. However, the plurality of light-shielding unit and the plurality of light-transmitting slit unit may be formed on one surface only of the transparent cover 130a.

Referring to FIG. 11, a first passenger (e.g., driver) in a first visual region inclusive of the driver's seat is allowed to watch only the image of a set of the first display regions 110a as a first image for the driver's seat due to the action of the optical separating elements 104a, while a second passenger (e.g., assistant driver) in a second visual region inclusive of the assistant driver's seat is allowed to watch only the image of a set of the second display regions 112a as a second image for the assistant driver's seat due to the action of the optical separating elements 104a. As described above, every other image is actually watched by dividing a single screen into a plurality of display regions in the longitudinal direction. By very decreasing the width of each display region, however, separate images can be simultaneously watched from both the driver's seat side and the assistant driver's seat side.

Desirably, the viewing angle, viewing range and crosstalk in the multi-view are determined by using light-transmitting slit units having a preset thickness and width.

In the multi-view display device of FIG. 10, a TV receiver 21, a navigation device 22 (guidance voice is a voice output) and a DVD replaying device 32 are installed as image/acoustic sources in an instrument panel in the compartment, enabling the images to be observed from different directions.

Further, the multi-view display device of FIG. 10 is provided with the display panel drive circuit 94. The display panel drive circuit 94 processes image data (image data of the two selected image/acoustic sources when the images of different image/acoustic sources are to be displayed) sent from the image/acoustic source that is selected to be displayed, and forms a signal for driving the multi-view display panel 20, so that the corresponding first image and second image are displayed on the multi-view display panel.

The multi-view display device of FIG. 10 further includes the input selecting circuit 80 which simultaneously receives the first image data and the second image data sent from the image/acoustic source. The input selecting circuit 80 sends, to the next stage, two kinds of image data (selected as the first image data and the second image data, the above image data may often be the same) of the image/acoustic source selected by the user.

Further, the image quality-adjusting unit 88 in the multi-view display device of FIG. 10 includes a first image quality adjusting circuit 81 for adjusting the quality of the first image and a second image quality adjusting circuit 82 for adjusting the quality of the second image. Here, the first image quality adjusting circuit 81 adjusts the quality of the first image independently of the second image quality adjusting circuit 82 that adjusts the quality of the second image. The image quality may be adjusted in an analog manner by the first and second image quality adjusting circuits 81 and 82. In practice, however, it is desired to adjust the image quality by storing the input image data in a digital form in a memory (not shown) for processing, and operating the image data.

The multi-view display circuit of FIG. 10 further includes the first writing circuit 91, second writing circuit 92, VRAM 93 and display panel drive circuit 94 described above. The first writing circuit 91 writes the image data output to odd columns of the screen of the multi-view display panel 20, into the corresponding columns of the VRAM 93, and the second writing circuit 91 writes the image data output to even columns of the screen, into the corresponding columns of the VRAM 93.

The display panel drive circuit 94 is a driver circuit for driving the liquid crystal display panel 100a, and drives corresponding pixels of the liquid crystal display panel 10a based on the first image data and the second image data held in the VRAM 93. As described already, the image data have been written in the VRAM 93 so as to correspond to the images for multi-view display. Therefore, only one drive circuit is required and its operation may be the same as the operation of the drive circuit in an ordinary liquid crystal display device.

Further, the multi-view display device of FIG. 10 includes the input selecting circuit 80, first image quality adjusting circuit 81, second image quality adjusting circuit 82, first writing circuit 91, second writing circuit 92, VPAM 93 and image control unit 8a for generally controlling the operation of the display panel drive circuit 94. The image control unit 8a is constituted by a microcomputer which includes a program storage unit 83 such as a ROM (read-only memory) for holding various kinds of programs necessary for operating the display device, and an image information storage unit 84 such as RAM for holding various kinds of data. Here, the ROM an RAM are provided on the outer side of the microcomputer. However, the ROM and RAN may be incorporated in the microcomputer.

Further, the multi-view display device of FIG. 10 is provided with an operating section 6a that includes an input section 60 such as operating keys of a touch panel or remote controller for inputting various data, and a selecting section (e.g., selecting button) 62 for selecting the state of adjusting the quality of the first image or the second image. As the operating section 6a, there can be exemplified a sound adjust operation start instructing unit for instructing the start of operation for adjusting the sound volume and/or the tone quality, a sound adjust operation end instructing unit for instructing the end of operation for adjusting the sound volume and/or the tone quality, and a sound adjust operating unit for adjusting the sound volume and/or the tone quality of the first sound and/or of the second sound. As the selecting section 62, there can be exemplified a sound adjust copy operating unit for instructing the copy of a sound adjust setpoint for replacing a sound adjust setpoint representing the state of adjusting the sound volume and/or the tone quality by the other sound adjust setpoint; a mode changeover operating unit; a sound volume adjust exchange operating unit for instructing the exchange of a sound adjust setpoint representing a state of adjusting the sound volume and/or the tone quality by a sound adjust setpoint representing another state of adjusting the sound volume and/or the tone quality; a sound adjust setpoint registration operating section (e.g., registration switch) for instructing the registration of a sound adjust setpoint representing a state of adjusting the sound volume and/or the tone quality; and a sound adjust setpoint read operating section (e.g., preset switch) for instructing a call of a sound adjust setpoint stored in advance or by a registration processing that will be described later. The selecting section 62 may be constituted by the operation keys of a touch panel or a remote controller, similar to the input section 60. Further, there may be provided a sound adjust setpoint registration/read operating unit (e.g., preset switch) that works as the above sound adjust setpoint registration operating unit and as the sound adjust setpoint read operating unit, to change over the function (registration instruction/read instruction) depending upon the operation state (pushed for a long period of time/pushed for a short period of time).

Further, the multi-view display device of FIG. 10 includes a variety of sensors 7a including a surrounding environment sensor (e.g., brightness sensor) 70 for detecting a change in the surrounding environment on the driver's seat side and on the assistant driver's seat side. As the surrounding environment sensor 70, there are separately provided a noise sensor for sensing noise that affects the sound volume and the tone quality and a window-is-open-or-closed sensor. The surrounding environment sensor 70 may be a common surrounding environment sensor for detecting, in common, a change in the surrounding environment (brightness, noise) at the driver's seat or at the assistant driver's seat, or may include a plurality of surrounding environment sensors for separately detecting changes in the surrounding environment at the driver's seat and the assistant driver's seat.

The multi-view display device of FIG. 10 is provided with a first sound output unit 51 for producing a first sound of the image/acoustic source selected for the driver's seat (first place) of the vehicle, and a second sound output unit 52 for producing a second sound of the image/acoustic source selected for the assistant driver's seat (second place). Here, a first sound is produced from a speaker of the first sound output unit 51 on the driver's seat side, and a second sound is produced from a speaker of the second sound output unit 52 on the assistant driver's seat side.

Further, the multi-view display device of FIG. 10 is provided with an acoustic control unit 1a , a sound volume/tone quality adjusting unit 33 and an output distributor circuit 4a.

If described in detail, the acoustic control unit la suitably processes first acoustic information (i.e., first acoustic signal) sent from a particular acoustic source and second acoustic information (i.e., second acoustic signal) sent from a particular image/acoustic source, and executes a suitable acoustic control for the sound volume/tone quality adjusting unit 33 and for the input selecting circuit 80, so that the corresponding first sound and the second sound can be output to the first sound output unit 51 and the second sound output unit 52. Desirably, the acoustic control unit 1a and the image control unit 8a are constituted by a common microcomputer.

The sound volume/tone quality adjusting unit 33 includes a first sound volume/tone quality adjusting circuit 3a-1 that adjusts the sound volume and the tone quality of the first acoustic signal being controlled by the acoustic control unit 1a , and a second sound volume/tone quality adjusting circuit 3a-2 that adjusts the sound volume and the tone quality of the second acoustic signal being controlled by the acoustic control unit 1a. The first sound volume/tone quality adjusting circuit 3a-1 and the second sound volume/tone quality adjusting circuit 3a-2 are constituted by using DSps that process acoustic signals of a digital form by using digital filters.

Here, the first sound volume/tone quality adjusting circuit 3a-1 has a function for adjusting the sound volume and the tone quality of the first acoustic signal of the image/acoustic source, and the second sound volume/tone quality adjusting circuit 3a-2 has a function for adjusting the sound volume and the tone quality of the second acoustic signal of the image/acoustic source. The first sound volume/tone quality adjusting circuit 3a-1 adjusts the sound volume and the tone quality of the first signal independently of the adjustment of the sound volume and the tone quality of the second acoustic signal by the second sound volume/tone quality adjusting circuit 3a-2.

The input selecting circuit 80 selects signals of acoustic sources input to the first sound volume/tone quality adjusting circuit 3a-1 and to the second sound volume/tone quality adjusting circuit 3a-2. Depending upon the state of selecting the image/acoustic source, the output distributor circuit 4a forms a first sound corresponding to the first acoustic signal of which the sound volume and tone quality are adjusted, and a second sound corresponding to the second acoustic signal. For example, the output distributor circuit 4a distributes acoustic signals, so that sounds corresponding to the images displayed to the seats are output from the speaker for the driver's seat and from the speaker for the assistant driver'seat. The input selecting circuit and the output distributor circuit can be constituted by using switching circuits or relays.

Finally, the first sound and the second sound formed by the output distributor circuit 4a are output from the first sound output unit 51 on the driver's seat side and from the second sound output unit 52 on the assistant driver's seat side that have been specified in advance. Thus, the sound volume/tone quality of each of the first sound and the second sound can be adjusted independently between the driver's seat side and the assistant driver's seat side.

The acoustic control unit 1a in the acoustic control device of FIG. 10 has a function for generally controlling the operations of the constituent elements such as the first sound volume/tone quality adjusting circuit 3a-1, second sound volume/tone quality adjusting circuit 3a-2 and distributor circuit 4a. The acoustic control unit 1a includes a program storage unit 11a such as ROM for holding various programs necessary for operating the multi-view display device, and a data storage unit such as RAM for holding various data related to the acoustic information. Here, the ROM and RAM are provided on the outer side of the acoustic control unit 1a. However, the ROM and RAM may be incorporated in the acoustic control unit 1a.

As the data storage unit, there can be exemplified a sound adjusting state storage unit 12a including a first sound adjust setpoint storage unit 17 for storing a sound adjust setpoint representing a state of adjusting the first sound and a second sound adjust setpoint storage unit 18 for storing a sound adjust setpoint representing a state of adjusting the second sound; and a setpoint holding section 15a for holding a plurality of sound adjust setpoints related to the first sound and the second sound. As the setpoint holding section, there can be exemplified a preset RAM (i.e., preset holding unit) that holds sound adjust setpoints of the first sound and/or of the second sound as preset values in advance or through the registration processing that will be described later; a sound adjust setpoint information storage unit for storing information related to the frequency of setting the sound adjust setpoints of the first sound and second sound; an environment adjust setpoint holding unit for holding sound adjust setpoints of the first sound and second sound set for the surrounding environment; an initial sound adjust setpoint storage unit for storing sound adjust setpoints that are to be set at the time of next start, such as sound adjust setpoint stored in the first sound adjust setpoint storage unit 17 and/or sound adjust setpoint stored in the second sound adjust setpoint storage unit 18 just before turning the power source off; and a mode storage unit for storing a mode selected by the mode changeover operating unit. As the data storage unit, there can be further exemplified an acoustic set point data storage section 16a such as passenger information storage unit for storing information related to a state of passengers (e.g., total number of the passengers, seats on which the passengers are seated) on board the vehicle.

If described in further detail, the preset RAM stores sound adjust setpoints of the sound volume and/or the tone quality of the first sound and/or the second sound in response to the sound adjust setpoint read operating unit (e.g., preset switch) in the selecting section 62. When the sound adjust setpoint read operating means is operated, the corresponding sound adjust setpoint is read out from the preset RAM, and is written into the first sound adjust setpoint storage unit 17 and/or the second sound adjust setpoint storage unit 18, so that the first sound and/or the second sound is adjusted based on the sound volume setpoint. On the other hand, when the sound adjust setpoint registration operating unit (e.g., registration switch) and the sound adjust setpoint read operating unit (e.g., preset switch) in the selecting section 62 are operated, the sound adjust setpoint written in the first sound adjust setpoint storage unit 17 and/or in the second sound adjust setpoint storage unit 18, is written into a region corresponding to the sound adjust setpoint read operating unit (e.g., preset switch) in the preset RAM. Another effective method may be the one in which some of the preset sound adjust setpoints of the preset RAM have been fixed in advance by the manufacturer. As described above, further, there may be provided a sound adjust setpoint registration/read operating unit that works both as the sound adjust setpoint registration operating unit and the sound adjust setpoint read operating unit, and the function (registration instruction/read instruction) may be changed over depending upon the state of operation (pushed for an extended period of time/pushed for a short period of time), Moreover, a plurality of sound adjust setpoints may be held for the sound adjust setpoint read operating unit. In this case, the sound adjust setpoints held in a region corresponding to the sound adjust setpoint read operating unit for which the preset RAM is operated, are cyclically read out for every operation of the sound adjust setpoint read operating unit.

Sound adjust setpoints are written into the first sound adjust setpoint storage unit 17 and into the second sound adjust setpoint storage unit 18. The first and second sound volume/tone quality adjusting circuits 3a-1 and 3a-2 adjust the sound volume and/or the tone quality of the sound depending upon the values written in the first and second sound adjust setpoint storage unit 17 and 18.

According to the multi-view display device of FIG. 10, the quality of the first image observed from the driver's seat is adjusted independently of the quality of the second image observed from the assistant driver's seat, and the image signals of which the image qualities are adjusted are written into the VRAM to display independent images depending on the driver's seat side and the assistant driver's seat side. Further, the sound volume and/or the tone quality of the first sound are adjusted on the driver's seat side independently of the sound volume and/or the tone quality of the second sound on the assistant driver's seat, and acoustic signals of which the sound volumes and tone qualities are adjusted are output from the first speaker and the second speaker that have been specified in advance to independently adjust the tone quality and/or the sound volume depending on the driver's seat side and the assistant driver's seat side. This makes it possible to adjust the display images to suit for the seats, i.e., to suite for the driver's seat and the assistant driver's seat, and to adjust the sounds to suite for the seats.

The processing for adjusting the sounds will be described later.

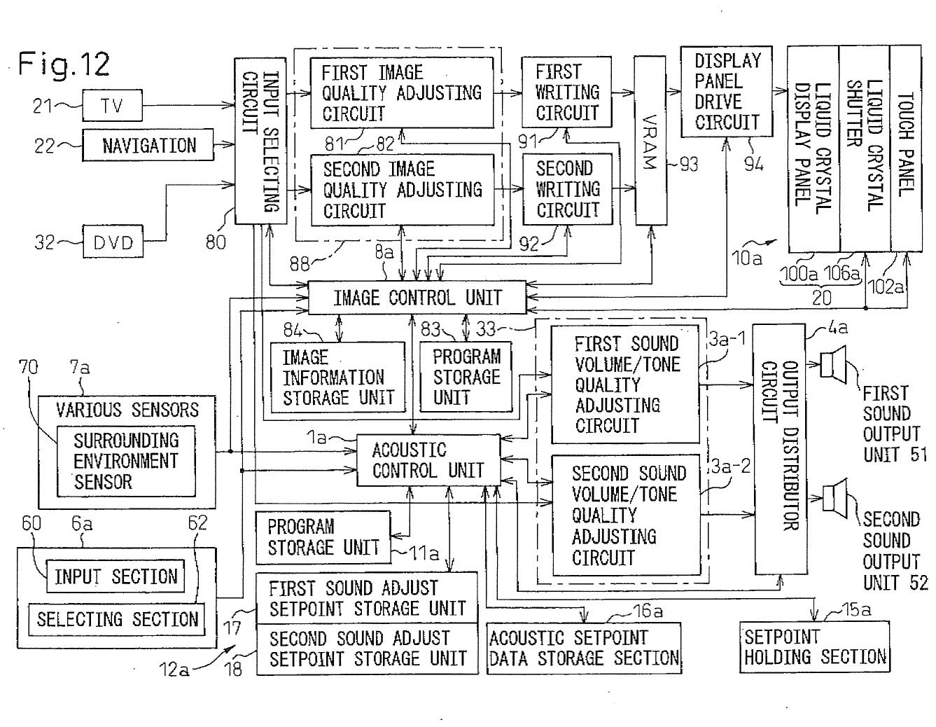

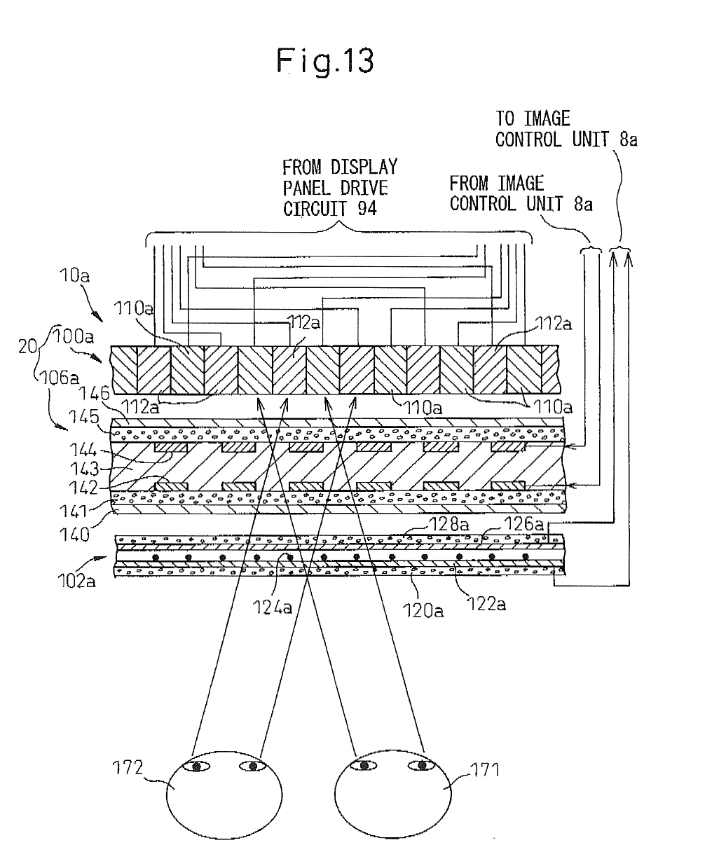

FIG. 12 is a block diagram illustrating the constitution of the multi-view display device according to a second embodiment of the present invention, and FIG. 13 is a view schematically illustrating the sectional shape of a display unit 10a in FIG. 12.

Schematically illustrated here is the constitution of the car-mounted multi-view display device in which two kinds of independent images are displayed on the screen of the same multi-view display panel 20 by writing two kinds of image data from the image/acoustic source and of which the image qualities have been separately adjusted into the VRAM 93 as in the case of the above embodiment of FIG. 10.

The multi-view display device according to the second embodiment shown in FIG. 12 is provided with a display unit 10a for providing a multi-view display for the driver's seat and the assistant driver's seat of the vehicle as in the case of the first embodiment of FIG. 10 above. Unlike the case of the first embodiment of FIG. 10 above, however, the display unit 10a of FIG. 12 has a liquid crystal shutter 106a instead of the optical separating element 104a formed on the front surface side of the liquid crystal display panel 100a. Concretely, the display unit 100a of FIG. 12 has the liquid crystal shutter 106a provided on the front surface side of the liquid crystal display panel 100a to form the multi-view display panel 20 which further has a touch panel 102a formed on the front surface thereof. In other respects, the constitution of the multi-view display device of FIG. 12 is the same as that of the first embodiment of FIG. 10 described above, Therefore, the following detailed description deals with the constituent elements of the display unit 10a only of FIGS. 12 and 13.

Referring to FIG. 12, the touch panel 102a is constituted by a pair of transparent insulating substrates 120a and 128a having flexibility, transparent electrodes 122a and 126a formed on the above pair of transparent insulating substrates, and dot spacers 124a arranged like a matrix on the transparent electrodes, as in the touch panel of FIG. 11 described above.

Similar to the multi-view display panel of FIG. 10 described above, the liquid crystal display panel 100a of FIG. 13 is constituted by a liquid crystal display panel and is divided into a plurality of belt-like display regions in the longitudinal direction, alternately forming first display regions 110a displaying the first image and second display regions 112a displaying the second image. The multi-view display panel 20 is formed by arranging the liquid crystal shutter 106a on the front surface side of the liquid crystal display panel 100a as described above. The display elements of the liquid crystal display panel 100a are driven and controlled by the display panel drive circuit 94.

The liquid crystal shutter 106 has a function of offering a multi-view display by separating the first image observed from the driver's seat and the second image observed from the assistant driver's seat from each other at a predetermined visual field angle. If described in further detail, the liquid crystal shutter 106a includes two pieces of transparent glass substrates 141 and 145, liquid crystals 143 sealed between these transparent glass substrates 141 and 145, and polarizer plates 140 and 146 arranged on the lower surface side of the transparent glass substrate 141 and on the upper surface side of the transparent glass substrate 145.

Transparent electrodes 142 of an ITO (indium-tin oxide) are formed on the surface of the transparent glass substrate 141 on the side of liquid crystals 143. Further, transparent electrodes 144 of ITO are formed on the transparent glass substrate 145 on the surface facing the transparent electrodes 142 on the side of liquid crystals 143. A major portion of the liquid crystal shutter 106a is constituted by the transparent electrodes 142 and 144 facing each other, and by the liquid crystals 143 between the transparent electrodes 142 and 144.

The transparent electrodes 142 and 144 are connected to the image control unit 8a (see FIG. 12) which feeds drive signals to the liquid crystal shutter 106a to drive it. In a state in which no voltage is applied by the drive signals between the one transparent electrode 142 and the other transparent electrode 144 in the thus constituted liquid crystal shutter 106a, the light that has passed through the liquid crystal display panel 100a reaches both the driver's seat and the assistant driver's seat passing through two pieces of polarizing plates arranged, for example, in cross-nicol.

When a predetermined voltage is applied between the one transparent electrode 142 and the other transparent electrode 144, on the other hand, the liquid crystals 143 vary their directions between the one transparent electrode 142 and the other transparent electrode 144, and light is shielded in the region between the transparent electrodes 142 and 144. As a result, a first passenger (e.g., driver) 171 in the first visual region inclusive of the driver's seat is allowed to watch the image of a set of the first display regions 110a as a first image for the driver's seat due to the action of the liquid crystal shutter 106a, and a second passenger (e.g., assistant driver) 172 in the second visual region inclusive of the assistant driver's seat is allowed to watch the image of a set of second display regions 112a as a second image for the assistant driver's seat due to the action of the liquid crystal shutter 106a. As described above, every other image is actually watched by dividing a single screen into a plurality of display regions in the longitudinal direction. By very decreasing the width of each display region, however, separate images can be simultaneously watched from both the driver's seat side and the assistant driver's seat side.

In the case of this constitution, the first image quality adjusting circuit 81 and the second image quality adjusting circuit 82 work to correct the qualities of the first image and the second image by varying the voltage applied between the one transparent electrode 142 and the other transparent electrode 144 to control the transmission factor of the liquid crystal shutter 106a.

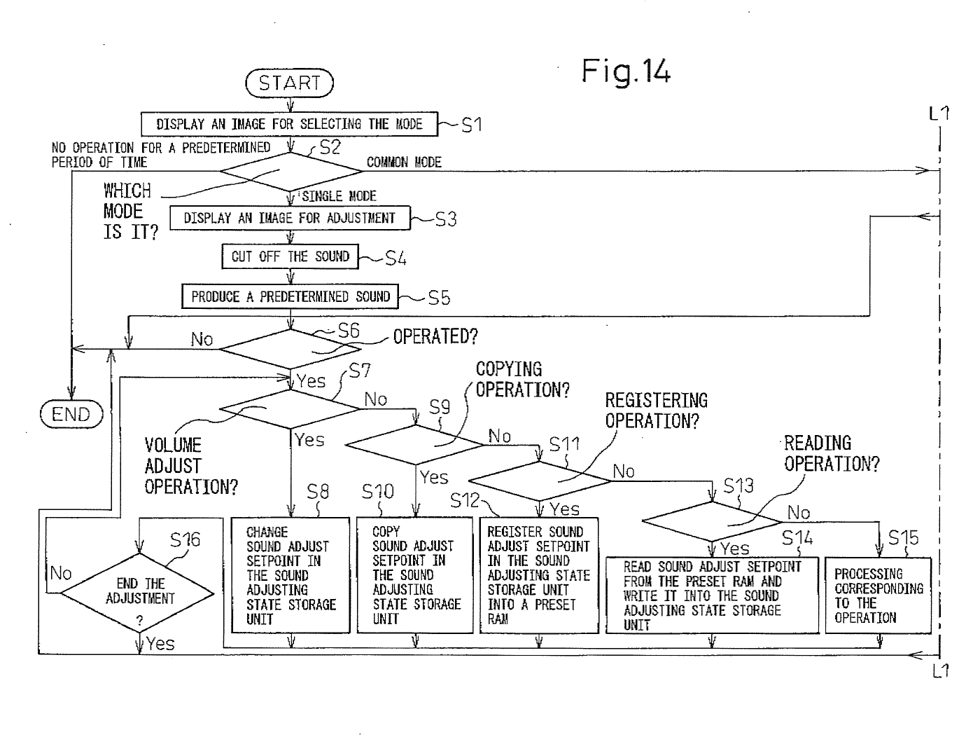

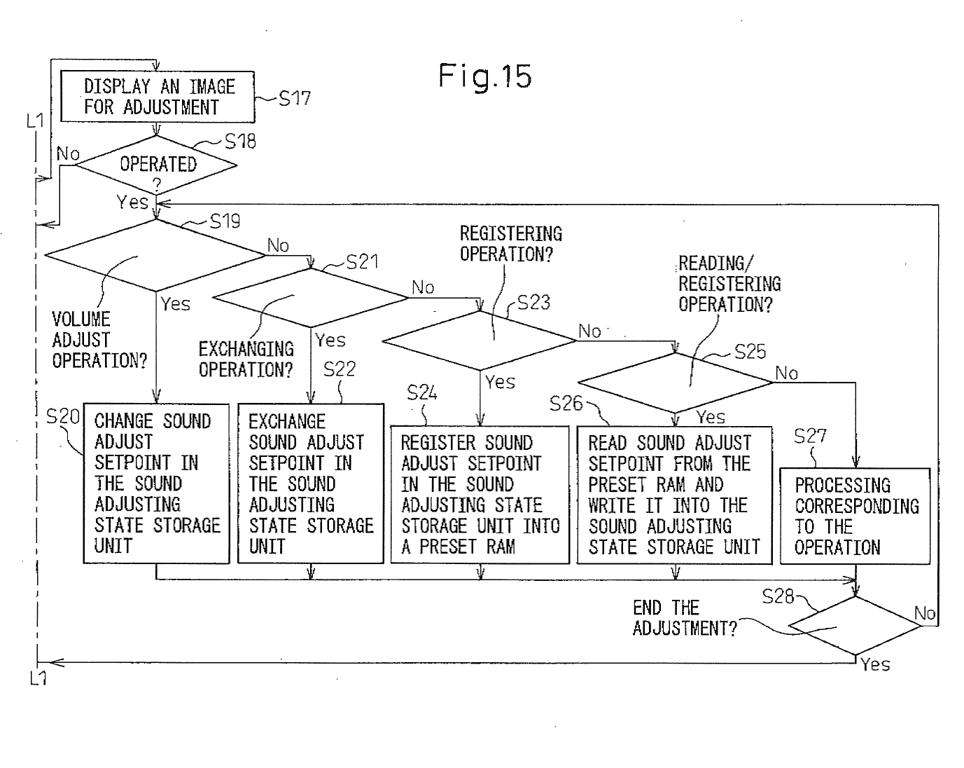

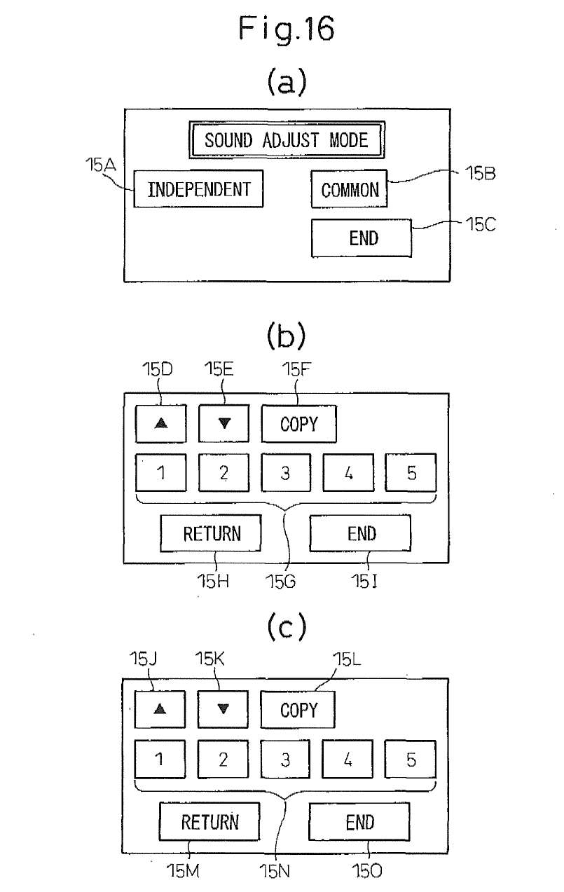

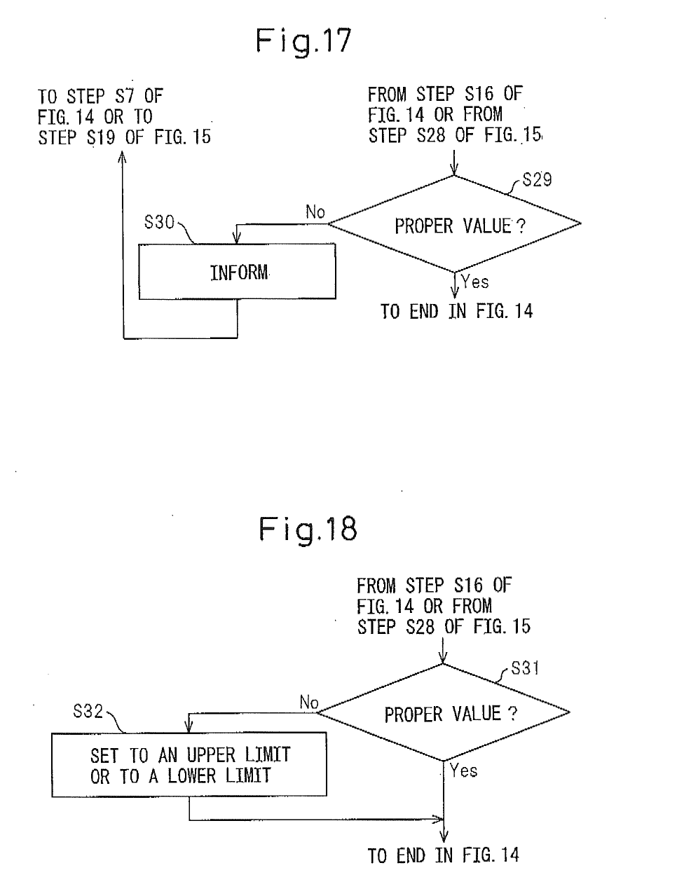

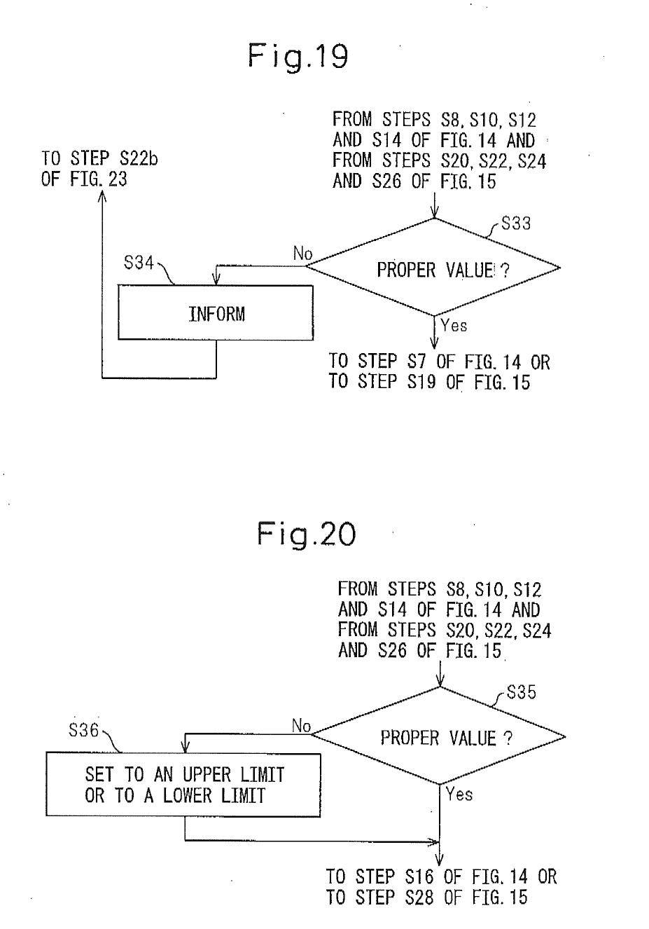

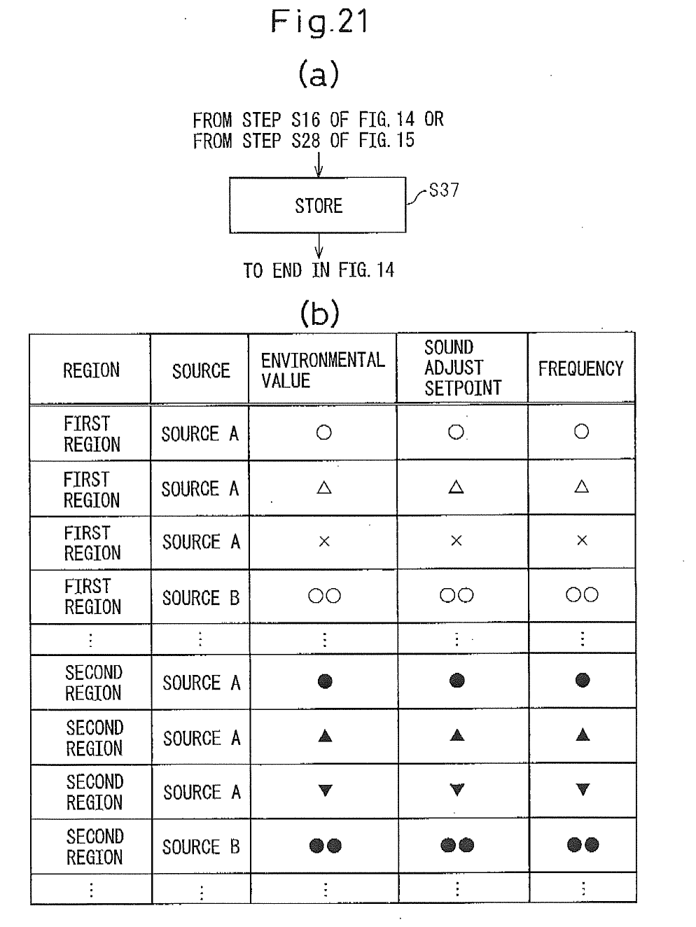

A sound adjust processing of the multi-view display device shown in FIGS. 10 to 13 will now be described with reference to FIGS. 14 and 15. FIGS. 14 and 15 are flowcharts (part 1 and part 2) for illustrating the sound adjust processing in the acoustic control unit 1a shown in FIGS. 10 and 12. Here, the acoustic control unit 1a represents a sound-adjusting unit, a voice adjust copy unit, a sound adjust exchange unit, a preset sound-adjusting unit, a preset registration unit, a mode changeover unit, a sound output cut-off unit, and an initial sound-adjusting unit.

This flowchart is executed when the acoustic control unit shown in FIGS. 10 and 12 has detected an instruction for starting the sound adjust operation for adjusting the sound volume and/or the tone quality from the sound adjust operation instructing unit in the input section 60. Namely, the flowchart is executed when the sound adjust operation instructing unit in the input unit 60 is operated by a user.

Steps S7 and S8 execute the sound adjust processing in an independent mode to adjust the sound adjust setpoint of the first sound or the second sound by detecting the operation of the sound adjust operating unit, steps S9 and S10 execute the sound adjust copy processing in the independent mode to use the other sound adjust setpoint as one sound adjust setpoint by detecting the operation of the sound adjust copy operating unit, steps S11 and S12 execute the preset processing for the sound adjust setpoint in the independent mode, steps S13 and S14 execute the preset read processing for the sound adjust setpoint in the independent mode, steps S19 and S20 execute the sound adjust processing in a common mode to adjust the sound adjust setpoint of the first sound or the second sound, steps S21 and S22 execute the sound adjust exchange processing in the common mode to exchange the sound adjust setpoint of the first sound with the sound adjust setpoint of the second sound, steps S23 and S24 execute the preset processing for the sound adjust setpoint in the common mode, and steps S25 and S26 execute the preset read processing for the sound adjust setpoint in the common mode.

The sound adjust processing described below is for adjusting the sound volume. The sound adjust processing, however, may be for adjusting the tone quality or for adjusting both the sound volume and the sound quality.

First, the image control unit 8a is instructed to display a mode selection image for selecting the independent mode/common mode shown in (a) portion of FIG. 16, and the display unit 10a displays a mode selection image (step S1 in FIG. 14). The mode selection image may be displayed in only a direction corresponding to the sound which is to be adjusted for its sound volume or may be displayed in both directions. Reference numeral 15A denotes a single mode selection operating unit, 15B denotes a common mode selection operating unit (15A and 15B correspond to the mode changeover operating unit), and 15C denotes an adjustment end switch (corresponds to the sound adjust operation end unit).

Next, it is judged if the operating section 6a (15A to 15C in (a) portion of FIG. 16) is operated. When the operation of the single mode selection operating unit 15A in the operating section 6a is detected, the routine proceeds to step S3. When the operation of the common mode selection operating unit 15B in the operating section 6a is detected, the routine proceeds to step S17. When the operation of the adjustment end switch 15C in the operating section 6a is detected or when the operation of none of them in the operating section 6a is detected for a predetermined period of time, the processing ends (step S2). Steps S1 and S2 correspond to the mode changeover unit. That is, step S2 judges the operation state of the mode changeover operating unit in the operating section 6a (selecting section 62) operated by the user, and the routine proceeds to step S3 in the case of the independent mode or the routine proceeds to step S17 in the case of the common mode.

Next, described below is the sound adjust processing in the independent mode.

At step S3, the image control unit 8a is instructed to display a single mode sound-adjusted image shown in (b) portion of FIG. 16, the display unit 10a displays the single mode sound-adjusted image, and the routine proceeds to step S4. In (b) portion of FIG. 16, reference numeral 15D denotes a volume-up switch (corresponds to the volume adjust operating unit), 1SE denotes a volume-down switch (corresponds to the volume adjust operating unit), 15F denotes a volume adjust setpoint copy switch (corresponds to the sound adjust copy operating unit), 15G denotes preset switches (corresponds to the sound adjust set registration/read operating unit), 15H denotes a return switch and 15I denotes an adjustment end switch (corresponds to the sound adjust operation end instructing unit).

Step S4 instructs cut-off of the sound output other than the sound that is to be adjusted so will not to be fed to the output distributor circuit 4a, and the routine proceeds to step S5.

At step S5, a predetermined sound for adjustment (e.g., white noise) of which the sound volume can be easily adjusted is produced from the sound output unit that produces the sound that is to be adjusted for its volume, and the routine proceeds to step S6.

At step S6, it is judged whether the operating section 6a (switches 15D to 15I in (b) portion of FIG. 16) is operated. When the operations of switches 15D to 15H in (b) portion of FIG. 16 are detected, the routine proceeds to step S7. When the operation of the operation end switch 15I (sound adjust operation end instructing unit) in the operating unit 6a is detected or when none of the operations of the operating section 6a (switches 15D to 15I in (b) portion of FIG. 16) is detected for a predetermined period of time, the processing ends.

At step S7, it is judged whether the operation detected at step 56 (or at step 516 described later) is the operation of the volume-up switch 15D or the volume-down switch 15E. When the detected operation is that of the volume-up switch 15D or of the volume-down switch 15E, the routine proceeds to step S8. When the detected operation is that of neither the volume-up switch 15D nor the volume-down switch 15E, the routine proceeds to step S9. That is, when the user at step S7 has adjusted the sound volume by using the volume adjust operating unit of the operating unit 6a (input section 60), the routine proceeds to step S8. In other cases, the routine proceeds to step S9.

At step S8, the sound adjust setpoint of sound which is to be adjusted is adjusted depending upon an instruction for adjusting the sound volume from the volume-up switch 15D or the volume-down switch 15E, the sound adjust setpoint held in the sound adjusting state storage unit 12a corresponding to the sound to be adjusted (first sound adjust setpoint storage unit 17 when the first sound is to be adjusted for its volume, or second sound adjust setpoint storage unit 18 when the second sound is to be adjusted) is rewritten by a volume adjust setpoint that is adjusted, a sound adjust instruction corresponding to the volume adjust setpoint after adjusted is output to the sound volume/tone quality adjusting circuit 33 corresponding to the sound that is to be adjusted (first sound volume/tone quality adjusting circuit 3a-1 when the first sound is to be adjusted for its volume or second sound volume/tone quality adjusting circuit 3a-2 when the second sound is to be adjusted), and the routine proceeds to step S16. Namely, at step S8, when the first sound is to be adjusted for its volume, the sound adjust setpoint in the first sound adjust setpoint storage unit 17 is rewritten depending upon the sound adjust instruction (user's sound adjust operation) from the sound adjust operating unit in the operating section 6a and, besides, the sound adjust instruction corresponding to the sound adjust setpoint written in the first sound adjust setpoint storage unit 17 is transmitted to the first sound volume/tone quality adjusting circuit 3a-1 to change the volume of the first sound. When the second sound is to be adjusted for its volume, the sound adjust setpoint in the second sound adjust setpoint storage unit 18 is rewritten depending upon the sound adjust instruction (user's sound adjust operation) from the sound adjust operating unit in the operating section 6a and, besides, the sound adjust instruction corresponding to the sound adjust setpoint written in the second sound adjust setpoint storage unit 18 is transmitted to the second sound volume/tone quality adjusting circuit 3a-2 to change the volume of the second sound. The routine, thereafter, proceeds to step 16.

In this processing, the sound volume and the tone quality of the sound produced on the other seat side can be adjusted from the one seat side of either the driver's seat side or the assistant driver's seat side and, hence, the sound produced on the other seat side is prevented from affecting the passenger on the one seat side. Further, even when the passenger on the other seat side does not know how to adjust the sound volume or the tone quality, the passenger on the one seat side is allowed to adjust the sound volume or the tone quality of the sound on the other seat side on his behalf.

At step S9, it is judged whether the operation detected at step S6 (or step S16 described later) is that of the sound adjust setpoint copy switch 15F. When the detected operation is that of the sound adjust setpoint copy switch 15F, the routine proceeds to step S10. When the detected operation is not that of the sound adjust setpoint copy switch 15F, the routine proceeds to step S1. When the operation for copying the sound adjust setpoint is effected by the user at step S9 by using the sound adjust copy operating unit of the operating section 6a (selecting section 62), the routine proceeds to step S10. In other cases, the routine proceeds to step S11.

At step S10, a sound adjust setpoint of a sound (e.g., second sound) which is not to be adjusted is read out from the sound adjusting state storage unit 12a (e.g., second sound adjust setpoint storage unit 18), a sound adjust setpoint in the sound adjusting state storage unit 12a (e.g., first sound adjust setpoint storage unit 17) corresponding to the sound to be adjusted (e.g., first sound) is read out from a sound (e.g., second sound) that is not to be adjusted, a sound adjust setpoint in the sound adjusting state storage unit 12a (e.g., first sound adjust setpoint storage unit 17) corresponding to the sound that is to be adjusted (e.g., first sound) is rewritten by a sound adjust setpoint read out from the sound adjusting state storage unit 12a (e.g., second sound adjust setpoint storage unit 18) corresponding to a sound (e.g., second sound) that is not to be adjusted, a sound adjust instruction corresponding to the sound adjust setpoint that is rewritten is output to the sound volume/tone quality adjusting unit 33 (e.g., first sound volume/tone quality adjusting circuit 3a-1) corresponding to the sound that is to be adjusted, and the routine proceeds to step S16. Namely, at step S10, the sound adjusting state of a sound (e.g., first sound) to be adjusted is changed into a sound adjusting state of a sound (e.g., second sound) that is not to be adjusted.

In this processing, when the user instructs to copy the sound adjust setpoint, the sound adjust setpoint of either the first sound or the second sound (which is to be adjusted) is changed into a sound adjust setpoint of the other sound (which is not to be adjusted). Concretely, when the sound adjusting state (sound adjust setpoint) of the first sound is to be changed into the sound adjusting state (sound adjust setpoint) of the second sound, the sound adjust setpoint in the first sound adjust setpoint storage unit 17 is rewritten by a value (sound adjust setpoint) stored in the second sound adjust setpoint storage unit 18. Alternatively, when the sound adjusting state (sound adjust setpoint) of the second sound is to be changed into the sound adjusting state (sound adjust setpoint) of the first sound, the sound adjust setpoint in the second sound adjust setpoint storage unit 18 is rewritten by a value (sound adjust setpoint) stored in the first sound adjust setpoint storage unit 17. Owing to this processing, a desired sound volume and tone quality can be handed over when the driver changes his seat. This processing corresponds to the sound adjust copy unit.

At step S13, it is judged if the operation detected at step S6 (or step S16 described later) is the one of when the preset switch 15G is pushed for an extended period of time. When the detected operation is the one as a result of pushing the preset switch 15G for an extended period of time, the routine proceeds to step S12. When the detected operation is not the one as a result of pushing the preset switch 15G for an extended period of time, the routine proceeds to step S13. Namely, the routine proceeds to step S12 when the user at step S11 has registered the sound volume adjust setpoint by using the sound adjust setpoint registration/read operating unit in the operating section 6a (selecting unit 62). In other cases, the routine proceeds to step S13. When there is provided the sound adjust setpoint registration/read operating unit that works both as the sound adjust setpoint registration operating unit and as the sound adjust setpoint read operating unit as in this embodiment, the operation for registering the sound adjust setpoint may be that of an embodiment different from the sound adjust setpoint read operation that will be described later. Alternatively, when the sound adjust setpoint registration operating unit and the sound adjust setpoint read operating unit are separately provided as described above, this embodiment may be suitably modified into the other embodiment such as simultaneously operating the sound adjust setpoint registration operating unit (registration switch) and the sound adjust setpoint read operating unit (preset switch). Alternatively, the sound adjust setpoint registration operating unit may be provided in a plural number as shown in (b) portion of FIG. 16 or may be provided in a single number though not illustrated. Further, they may be provided in common for the sounds, or may be separately provided for each of the sounds.

At step S12, a sound adjust setpoint stored in the sound adjusting state storage unit 12a corresponding to the sound to be adjusted is read out, is written into a corresponding region of the setpoint holding section 15a (e.g., preset RAM) that corresponds to the operated preset switch 15G, and the routine proceeds to step S16. That is, when the first sound is the one that is to be adjusted, the sound adjust setpoint stored in the first sound adjust setpoint storage unit 17 is written into a corresponding region of the setpoint holding section 15a that corresponds to the sound adjust setpoint registration/read operating unit that is operated due to the registration instruction (user's registration operation) from the operating section 6a (selecting unit 62). Alternatively, when the second sound is the one that is to be adjusted, the sound adjust setpoint stored in the second sound adjust setpoint storage unit 18 is written into a corresponding region of the setpoint holding unit 15a that corresponds to the sound adjust setpoint registration/read operating unit that is operated. The sound adjust setpoint may be written in a number of only one or in a plural number into the region of the setpoint holding section 15a that corresponds to one of the sound adjust setpoint registration/read operating unit. This processing corresponds to the preset registration unit.

At step S13, it is judged whether the operation detected at step S6 (or step S16 described later) is the one as a result of pushing the preset switch 15G for a short period of time. When the detected operation is the one as a result of pushing the preset switch 15G for a short period of time, the routine proceeds to step S14. When the detected operation is not the one as a result of pushing the preset switch 15G for a short period of time, the routine proceeds to step S15. That is, when the user at step S13 reads the sound volume adjust setpoint by using the sound adjust setpoint registration/read operating unit of the operating section 6a (selecting section 62), the routine proceeds to step S14. In other cases, the routine proceeds to step S15.

At step S14, the sound adjust setpoint is read out from a region of the setpoint holding unit 15a corresponding to the preset switch 15G that is operated, the sound adjust setpoint in the sound adjusting state storage unit 12a (e.g., first sound adjust setpoint storage unit 17) corresponding to a sound (e.g., first sound) to be adjusted is rewritten by the sound adjust setpoint that is read out, and a sound adjust instruction corresponding to the sound adjust setpoint that is rewritten is output to the sound volume/tone quality adjusting unit 33 (e.g., first sound volume/tone quality adjusting circuit 3a-1) corresponding to the sound that is to be adjusted. Thus, the sound adjust setpoint of sound that is to be adjusted is rewritten by the predetermined sound adjust setpoint stored in the setpoint holding section 15a.

In this processing, when the read operation of the sound adjust setpoint registration/read operating unit (e.g., preset switch) is executed, the sound adjust setpoint is read out from a region of the setpoint holding unit 15a corresponding to the sound adjust setpoint registration/read operating unit (e.g., preset switch) that is operated to set a sound adjust setpoint of the sound (first sound or second sound) that is to be adjusted. In this constitution, sounds can be easily adjusted by using sound adjust setpoints held in advance in the setpoint holding unit 15a (preset by the manufacturer or preset by the user). When a plurality of sound adjust setpoints are stored for one sound adjust setpoint registration/read operating unit, the sound adjust setpoints stored for every operation of the sound adjust setpoint registration/read operating unit may be read out cyclically. This processing corresponds to the preset sound-adjusting unit. The operation detected at step S6 (or step S16 described later) is the one by none of the volume-up switch 15D, volume-down switch 15E, sound volume adjust setpoint copy switch 15F or preset switch 15G. Therefore, a processing corresponding to the operation is executed at step S15, and the routine proceeds to step S16. When the operation that is detected is that of the return switch 15H shown in (b) portion of FIG. 16, the routine returns back to step S2. When the operation that is detected is that of the adjustment end switch 15I, the processing ends.

When the operation of the adjustment end switch 15I is detected or when none of the operations of the operating unit 6a is detected for a predetermined period of time, the processing ends at step S16. When the operation is detected which is not that of the adjustment end switch 15I, the routine proceeds to step S7. When the routine proceeds to step S7, the processings at steps S7 to S15 are executed based on the operation detected at step S16.

Next, described below is the sound adjust processing in the common mode.

At step S17 in FIG. 15, the image control unit 8a is instructed to display a common mode sound-adjusted image shown in (c) portion of FIG. 16, the display unit 10a displays the single mode sound-adjusted image, and the routine proceeds to step S18. In (c) portion of FIG. 16, reference numeral 15J denotes a volume-up switch (corresponds to the sound adjust operating unit), 15K denotes a volume-down switch (corresponds to the volume adjust operating unit), 15L denotes a volume adjust setpoint copy switch (corresponds to the sound adjust copy operating unit) or a volume adjust setpoint exchange switch, 15N denotes preset switches (sound adjust set registration/read operating unit), 15M denotes a return switch and 15O denotes an adjustment end switch (corresponds to sound adjust operation end instructing unit).

At step S18, it is judged whether the operating unit 6a (15J to 15O in (c) portion of FIG. 16) is operated. When the operations of 15J to 15M in (c) portion of FIG. 16 are detected, the routine proceeds to step S19. When the operation of the operation end switch 15O (sound adjust operation end instructing unit) in the operating section 6a is detected or when none of the operations of the operating section 6a (15J to 15O in (c) portion of FIG. 15) is detected for a predetermined period of time, the processing ends.

At step S19, it is judged whether the operation detected at step S18 (or at step S28 described later) is the operation of the volume-up switch 15J or the volume-down switch 15K. When the detected operation is that of the volume-up switch 15J or of the volume-down switch 15K, the routine proceeds to step S20. When the detected operation is that of neither the volume-up switch 15J nor the volume-down switch 15K, the routine proceeds to step S21. That is, when the user at step S19 has adjusted the sound volume by using the volume adjust operating unit of the operating section 6a (input section 60), the routine proceeds to step S20. In other cases, the routine proceeds to step S21.

At step S20, the sound adjust setpoints of the first sound and the second sound are adjusted depending upon an instruction for adjusting the sound volume from the volume-up switch 15J or the volume-down switch 15K, the sound adjust setpoints held in the sound adjusting state storage unit 12a (first sound adjust setpoint storage unit 17 and second sound adjust setpoint storage unit 18) are rewritten by the volume adjust setpoints after adjusted, sound adjust instructions corresponding to the volume adjust setpoints after adjusted are output to the sound volume/tone quality adjusting unit 33 (first sound volume/tone quality adjusting circuit 3a-1 and second sound volume/tone quality adjusting circuit 3a-2), and the routine proceeds to step S28. Namely, at step S20, the sound adjust setpoints in the first sound adjust setpoint storage unit 17 and in the second sound adjust setpoint storage unit 18 are rewritten depending upon the sound adjust instructions (user's sound adjust operation) from the sound adjust operating unit in the operating section 6a and, besides, the sound adjust instructions corresponding to the sound adjust setpoints written in the first sound adjust setpoint storage unit 17 and in the second sound adjust setpoint storage unit 18 are transmitted to the first sound volume/tone quality adjusting circuit 3a-1 and to the second sound volume/tone quality adjusting circuit 3a-2 to change the volume of the first sound and the volume of the second sound, and the routine proceeds to step S28. Here, the sound adjustment at step S20 may be such that the first sound and the second sound acquire the same volume (the same sound adjust setpoint is possessed by the first sound adjust setpoint storage unit 17 and by the second sound adjust setpoint storage unit 18). The sound adjust setpoints of the sounds may be adjusted in the same direction (plus direction or minus direction) by the same value.

At step S21, it is judged whether the operation detected at step S18 (or step S28 described later) is that of the sound adjust setpoint exchange switch 15L. When the detected operation is that of the sound adjust setpoint exchange switch 15L, the routine proceeds to step S22. When the detected operation is not that of the sound adjust setpoint exchange switch 15L, the routine proceeds to step S23. When the operation for copying the sound adjust setpoint is effected by the user at step S21 by using the sound adjust exchange operation unit of the operating section 6a (selecting section 62), the routine proceeds to step S22. In other cases, the routine proceeds to step S23.

At step S22, a sound adjust setpoint of a sound (e.g., first sound) is read out from the sound adjusting state storage unit 12a (e.g., first sound adjust setpoint storage unit 17) corresponding to a sound (e.g., first sound), and a sound adjust setpoint of the other sound (e.g., second sound) is read out from the sound adjusting state storage unit 12a (e.g., second sound adjust setpoint storage unit 18) corresponding to the other sound (e.g., second sound). The sound adjust setpoint held in the sound adjusting state storage unit 12a (e.g., second sound adjust setpoint storage unit 18) corresponding to the other sound (e.g., second sound) is rewritten by a sound adjust setpoint of the sound (e.g., first sound) that is read out, and the sound adjust setpoint held in the sound adjusting state storage unit 12a (e.g., first sound adjust setpoint storage unit 17) corresponding to the one sound (e.g., first sound) is rewritten by a sound adjust setpoint of the other sound (e.g., second sound) that is read out. The sound adjust instructions corresponding to the sound adjust setpoints that are rewritten are output to their corresponding sound volume/tone quality adjusting unit 33 (first sound volume/tone quality adjusting circuit 3a-1 and second sound volume/tone quality adjusting circuit 3a-2), and the routine proceeds to step S28. Thus, the sound adjusting state of one sound (e.g., first sound) is changed into the sound adjusting state of the other sound (e.g., second sound), and the sound adjusting state of the other sound (e.g., second sound) is changed into the sound adjusting state of the one sound (e.g., first sound). Here, at step S22, the sound adjust setpoints corresponding to the sounds are once read out from the sound adjusting state storage unit 12a (first sound adjust setpoint storage unit 17 and second sound adjust setpoint storage unit 18) to rewrite the sound adjust setpoints in the sound adjusting state storage unit 12a (first sound adjust setpoint storage unit 17 and second sound adjust setpoint storage unit 18). However, it is also allowable to change the definition of the sound adjusting state storage unit 12a (change the first sound adjust setpoint storage unit 17 over to the second sound adjust setpoint storage unit 18, and change the second sound adjust setpoint storage unit 18 over to the first sound adjust setpoint storage unit 17).

In this processing, when the user instructs to exchange the sound adjust setpoint by operating the sound adjust setpoint exchange operating unit in the operating section 6a (selecting section 62), the sound adjusting state (sound adjust setpoint) of the first sound is changed into the sound adjusting state (sound adjust setpoint) of the second sound, and the sound adjusting state (sound adjust setpoint) of the second sound is changed into the sound adjusting state (sound adjust setpoint) of the first sound. Namely, the value in the first sound adjust setpoint storage unit 17 is exchanged by the sound adjust setpoint stored in the second sound adjust setpoint storage unit 18. Owing to this processing, desired sound volume and tone quality can be handed over when the passengers on the driver's seat and on the assistant driver's seat are to change their seats after having driven for extended periods of time. This processing corresponds to the sound adjust exchange unit.

At step S23, it is judged if the operation detected at step S18 (or step S28 described later) is the one of when the preset switch 15N is pushed for an extended period of time. When the detected operation is the one as a result of pushing the preset switch 15N for an extended period of time, the routine proceeds to step S24. When the detected operation is not the one as a result of pushing the preset switch 15N for an extended period of time, the routine proceeds to step S25. Namely, the routine proceeds to step S24 when the user at step S23 has registered the sound volume adjust setpoint by using the sound adjust setpoint registration/read operating unit in the operating section 6a (selecting section 62). In other cases, the routine proceeds to step S25. When there is provided the sound adjust setpoint registration/read operating unit that works both as the sound adjust setpoint registration operating unit and as the sound adjust setpoint read operating unit as in this embodiment, the embodiment may be differed from the sound adjust setpoint read operation that will be described below. Alternatively, when the sound adjust setpoint registration operating unit and the sound adjust setpoint read operating unit are separately provided as described above, this embodiment may be suitably modified into the other embodiment such as simultaneously operating the sound adjust setpoint registration operating unit (registration switch) and the sound adjust setpoint read operating unit (preset switch). Alternatively, the sound adjust setpoint registration operating unit may be provided in a plural number as shown in (c) portion of FIG. 16 or may be provided in a single number though not illustrated. Further, they may be provided in common for the sounds, or may be separately provided for each of the sounds.

At step S24, a sound adjust setpoints stored in the sound adjusting state storage unit 12a (first sound adjust setpoint storage unit 17 and second sound adjust setpoint storage unit 18) are read out, are written into a corresponding region of the setpoint holding section 15a (e.g., preset RAM) that corresponds to the preset switch 15N that is operated, and the routine proceeds to step S28. That is, the sound adjust setpoint stored in the first sound adjust setpoint storage unit 17 and the sound adjust setpoint stored in the second sound adjust setpoint storage unit 18 are written into a corresponding region of the setpoint holding section 15a that corresponds to the sound adjust setpoint registration/read operating unit that is operated due to the registration instruction (user's registration operation) from the operating section 6a (selecting section 62). Here, as described above, the sound adjust setpoint may be written in a number of only one or in a plural number into the region of the setpoint holding section 15a that corresponds to one of the sound adjust setpoint registration/read operating units. Further, the sound adjust setpoint written in the setpoint holding section 15a may be registered for each of the sounds. This processing corresponds to the preset registering unit.

At step S25, it is judged whether the operation detected at step S18 (or step S28 described later) is the one as a result of pushing the preset switch 15N for a short period of time. When the detected operation is the one as a result of pushing the preset switch 15N for a short period of time, the routine proceeds to step S26. When the detected operation is not the one as a result of pushing the preset switch 15N for a short period of time, the routine proceeds to step S27. That is, when the user at step S25 reads the sound volume adjust setpoint by using the sound adjust setpoint registration/read operating unit of the operating section 6a (selecting section 62), the routine proceeds to step S26. In other cases, the routine proceeds to step S27.

At step S26, the sound adjust setpoints are read out from a region of the setpoint holding section 15a corresponding to the preset switch 15N that is operated, the sound adjust setpoints in the sound adjusting state storage unit 12a (first sound adjust setpoint storage unit 17 and second sound adjust setpoint storage unit 18) are rewritten by the sound adjust setpoints that are read out, and sound adjust instructions corresponding to the sound adjust setpoints that are rewritten are output to the corresponding sound volume/tone quality adjusting unit 33 (first sound volume/tone quality adjusting circuit 3a-1 and second sound volume/tone quality adjusting circuit 3a-2). Thus, the sound adjust setpoints of the first sound and the second sound are rewritten into predetermined sound adjust setpoints stored in the setpoint holding section 15a.

In this processing, when the read operation of the sound adjust setpoint registration/read operating unit (e.g., preset switch) is executed, the sound adjust setpoints are read out from a region of the setpoint holding section 15a corresponding to the sound adjust setpoint registration/read operating unit (e.g., preset switch) that is operated to set sound adjust setpoints of the first sound and the second sound. In this constitution, sounds can be easily adjusted by using sound adjust setpoints held in advance in the setpoint holding section 15a (preset by the manufacturer or preset by the user). When a plurality of sound adjust setpoints are stored for one sound adjust setpoint registration/read operating unit as described above, the sound adjust setpoints stored for every operation of the sound adjust setpoint registration/read operating unit may be read out cyclically. Here, when different sound adjust setpoints are held depending upon the sounds for one sound adjust setpoint registration/read operating unit, a different sound adjust setpoint can be read out for each of the sounds.

The operation detected at step S18 (or step S28 described later) is the one by none of the volume-up switch 15J, volume-down switch 15K, sound volume adjust setpoint copy switch 15L and preset switch 15N. Therefore, a processing corresponding to the operation is executed at step S27, and the routine proceeds to step S28. When the operation that is detected is that of the return switch 15M shown in (c) portion of FIG. 16, the routine returns back to step S2. When the operation that is detected is that of the adjustment end switch 15O, the processing ends.

When the operation of the adjustment end switch 15O is detected or when none of the operations of the operating unit 6a is detected for a predetermined period of time, the processing ends at step S28. When the operation is detected which is not that of the adjustment end switch 15O, the routine proceeds to step S7. When the routine proceeds to step S19, the processings at steps S19 to S27 are executed based on the operation detected at step S28.

Upon selecting the independent mode or the common mode as described above, it is allowed to generally adjust the first sound and the second sound (same sound adjusting state or adjustment in the same direction) or to adjust the sound adjusting state independently for the sounds.

The above copy processing may be executed in the common mode, and the above exchange processing may be executed in the single mode.

A predetermined sound may be output in the common mode, too, for easy adjustment of the sound.

Modified examples of the sound adjust processing of the acoustic control unit la shown in FIGS. 14 and 15 will now be described with reference to FIGS. 17 to 21. FIGS. 17 to 21 are flowcharts for illustrating the sound adjust processing having an upper limit and a lower limit imposed on the volume adjust setpoint, wherein FIG. 17 is a flowchart illustrating a first modified example, FIG. 18 is a flowchart illustrating a second modified example, FIG. 19 is a flowchart illustrating a third modified example, and FIG. 20 is a flowchart illustrating a fourth modified example. Further, (a) portion of FIG. 21 shows a flowchart illustrating a processing for holding the adjusted sound adjust setpoint in the setpoint holding section 15a and (b) portion of FIG. 21 shows a diagram illustrating an example in which the sound adjust setpoints are held in the setpoint holding section 15a. The sound adjust processings of FIGS. 17 to 21 can be suitably added to the sound adjust processing of FIGS. 14 and 15.

Described below are the sound adjust processings of FIGS. 17 to 20. In these processings, adjustable ranges (proper ranges) have been set in advance for adjusting the sound adjust setpoints.

First, the sound adjust processing of FIG. 17 will be described.

The routine proceeds to step S29 when the operation of the adjust end switch 15I is detected or when none of the operations of the operating section 6a is detected for a predetermined period of time at step S16 in FIG. 14, or when the operation of the adjust end switch 150 is detected or when none of the operations of the operating section 6a is detected for a predetermined period of time at step S28 in FIG. 15. At step S29, it is judged if the sound adjust setpoint adjusted through the sound adjust processing of FIGS. 14 and 15 is within a preset adjustable range (proper range). When it is within the proper range, the routine ends in FIG. 14. When it is outside the proper range, the routine proceeds to step S30.

At step S30, an instruction is output to the corresponding constitutions to let the user know that the sound adjust setpoint that is adjusted is outside the proper range. The routine proceeds to step S7 of FIG. 14 when it has shifted from step S16 of FIG. 14 to step S30. Or, the routine proceeds to step S19 of FIG. 15 when it has shifted from step S28 of FIG. 15 to step S30.

That is, when the sound adjust setpoint after adjusted is outside the proper range, the sound adjust processing is not finished and, besides, the sound adjust setpoint is so adjusted as to lie within the proper range.

Next, the sound adjust processing of FIG. 18 will be described.

The routine proceeds to step S31 when the operation of the adjust end switch 15I is detected or when none of the operations of the operating section 6a is detected for a predetermined period of time at step S16 in FIG. 14, or when the operation of the adjust end switch 150 is detected or when none of the operations of the operating section 6a is detected for a predetermined period of time at step S28 in FIG. 15. At step S31, it is judged if the sound adjust setpoint adjusted through the sound adjust processing of FIGS. 14 and 15 is within a preset adjustable range (proper range). When it is within the proper range, the routine ends in FIG. 14. When it is outside the proper range, the routine proceeds to step S32.

At step S32, the sound adjust setpoint is adjusted to be an upper limit or a lower limit, which is written into a corresponding sound adjusting state storage unit 12a , a sound adjust instruction corresponding to the upper limit or the lower limit of the adjustable range is output to a corresponding sound volume/tone quality adjusting unit 33, and the routine proceeds to the processing of FIG. 14.

That is, when the sound adjust setpoint after adjusted is outside the proper range, the sound adjust setpoint is set to a sound adjusting state at the upper limit or the lower limit of the adjustable range.

Next, the sound adjust processing of FIG. 19 will be described.

The sound adjust processings of FIG. 14 and 15 (steps S8, S10, S12 and S14 of FIG. 14 and steps S20, S22, S24 and S26 of FIG. 15) are executed, and the routine proceeds to step S33. At step S33, it is judged if the sound adjust setpoint adjusted through the sound adjust processing of FIGS. 14 and 15 is within the preset adjustable range (proper range). The routine proceeds to step S16 of FIG. 14 when it has shifted to step S33 from steps S8, S10, S12 and S14 of FIG. 14 within the proper range. Alternatively, the routine proceeds to step S28 of FIG. 15 when it has shifted to step S33 from steps S20, S22, S24 and S26 of FIG. 15 within the proper range. When it lies outside the proper range, the routine proceeds to step S34.

At step S34, an instruction is output to the corresponding constitutions to let the user know that the sound adjust setpoint after adjusted is outside the proper range. The routine proceeds to step S7 of FIG. 14 when it has shifted to step S33 from steps S8, S10, S12 and S14 of FIG. 14. Alternatively, the routine proceeds to step S19 of FIG. 15 when it has shifted to step S33 from steps S20, S22, S24 and S26 of FIG. 15. When it lies outside the proper range, the routine proceeds to step S34. The routine proceeds to step S7 of FIG. 14 when it has shifted from step S16 of FIG. 14 to the main processing of step S30. On the other hand, the routine proceeds to step S19 of FIG. 15 when it has shifted from step S28 of FIG. 15 to the main processing of step S30.

That is, when the sound adjust setpoint after adjusted is outside the proper range, the sound adjust processing is not finished and, besides, the sound adjust setpoint is so adjusted as to lie within the proper range.

Next, the sound adjust processing of FIG. 20 will be described.

The sound adjust processings of FIG. 14 and 15 (steps S8, S10, 812 and 814 of FIG. 14 and steps 520, S22, S24 and 526 of FIG. 15) are executed, and the routine proceeds to step S35. At step S35, it is judged if the sound setpoint adjusted through the sound adjust processing of FIGS. 14 and 15 is within the preset adjustable range (proper range). The routine proceeds to step S16 of FIG. 14 when it has shifted to step S35 from steps S8, S10, S12 and S14 of FIG. 14 within the proper range. Alternatively, the routine proceeds to step S28 of FIG. 15 when it has shifted to step S35 from steps S20, S22, S24 and S26 of FIG. 15 within the proper range. When it lies outside the proper range, the routine proceeds to step S36.

At step S36, the sound adjust setpoint is adjusted to be an upper limit or a lower limit, is written into a corresponding sound adjusting state storage unit 12a , and a sound adjust instruction corresponding to the upper limit or the lower limit of the adjustable range is output to a corresponding sound volume/tone quality adjusting unit 33. The routine proceeds to step S16 of FIG. 14 when it has shifted to step S35 from steps S8, S10, S12 and S14 of FIG. 14. Alternatively, the routine proceeds to step S28 of FIG. 15 when it has shifted to step 835 from steps S20, S22, S24 and S26 of FIG. 15.

That is, when the sound adjust setpoint after adjusted is outside the proper range, the sound adjust setpoint is set to a sound adjusting state at the upper limit or the lower limit of the adjustable range, so that the sounds heard by the passengers on their seats do not become offensive to the passengers on the other seats.

The adjustable range may have been fixed or may be set based on the results detected by the surrounding environment sensors.

Next, described below with reference to FIG. 21 is a processing for storing the sound adjust setpoint adjusted through the sound adjust processing of FIG. 14 in the setpoint holding section 15a. Here, (a) portion of FIG. 21 shows a flowchart illustrating a processing for storing the sound adjust setpoint adjusted through the sound adjust processing of FIG. 14 in the setpoint holding section 15a, and (b) portion of FIG. 21 shows a diagram illustrating an example of storing sound adjust setpoints in the setpoint holding section 15a.

The routine proceeds to step S37 when the operation of the adjust end switch 15I is detected or when none of the operations of the operating section 6a is detected for a predetermined period of time at step S16 in FIG. 14, or when the operation of the adjust end switch 150 is detected or when none of the operations of the operating section 6a is detected for a predetermined period of time at step S28 in FIG. 15. At step S37, the sound adjust setpoint and the frequency thereof (i.e. the number in which a plurality of sound adjust setpoints are set repeatedly adjusted through the sound adjust processing of FIGS. 14 and 15 is written into the setpoint holding section 15a as shown in (b) portion of FIG. 21, and the routine ends in FIG. 14.

In this case, (b) portion of FIG. 21 shows only one example, and the storage method may be such that the sound adjust setpoint and at least another one of the items are stored in a pair.

The sound adjust setpoint stored in this processing can be used for the sound adjust processing at the start or at a moment when an environmental change is detected as will be described later.

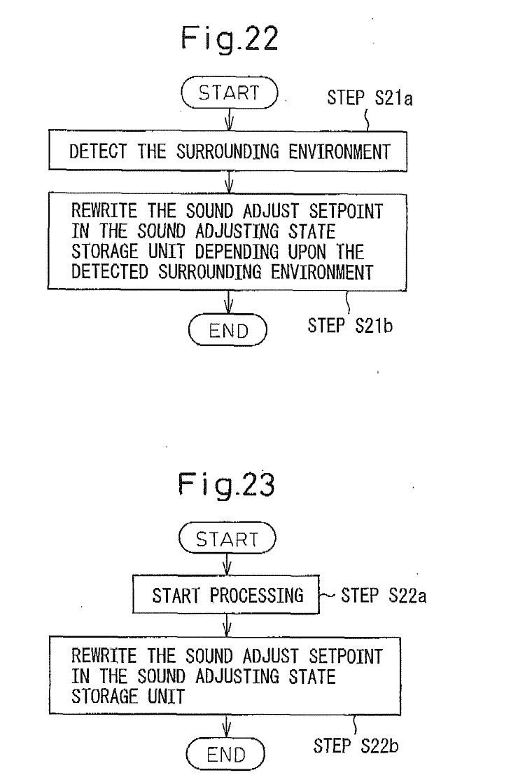

Next, described below with reference to FIG. 22 is a sound adjust processing by the acoustic control unit la in the multi-view display device shown in FIGS. 10 and 12 depending upon a change in the environment. This flowchart is regularly executed while the power source of the multi-view display device shown in FIGS. 10 and 12 is turned on (or while the multi-view is being displayed).

First, a surrounding environment is detected by the surrounding environment sensor 70, and the routine proceeds to step S21b (step S21a). As described above, the surrounding environment sensor 70 may be the one for detecting the surrounding environments on the driver's seat side and on the assistant driver's seat side in common, or may be provided in a plural number for separately detecting the surrounding environments on the driver's seat side and on the assistant driver's seat side.

Depending upon the result detected by the surrounding environment sensor 70 at step S21b, the sound adjust setpoints in the sound adjusting state storage unit 12a (first sound adjust setpoint storage unit 17 and second sound adjust setpoint storage unit 18) are adjusted based on the sound adjust setpoints stored in the setpoint holding section 15a, and a sound adjust instruction corresponding to the sound adjust setpoint after adjusted is output to the sound volume/tone quality adjusting unit 33 to end the processing. According to this processing, the two sounds (first sound and second sound) are adjusted depending upon the result detected by the surrounding environment sensor 70, making it possible to automatically and generally adjust the sounds for the surrounding environment that affects the sounds.

Here, the sound may be adjusted upon detecting the amount of change in the surrounding environment. The setpoint holding section 15a may store, as sound adjust setpoints, sound adjust setpoints that vary depending upon the environment or sound adjust setpoints that vary depending upon the amount of change in the environment. Further, the sound adjust setpoints may be the fixed values that have been stored in advance by the manufacturer, or may be the sound adjust setpoints stored through the processing described with reference to FIG. 21 mentioned above. Further, the sound adjust setpoints may be stored for each of the sounds.

When the surrounding environment sensor 70 is to detect the surrounding environments on the driver's seat side and on the assistant driver's seat side in common, the first sound and the second sound can be adjusted in the same direction or can be adjusted into the same sound adjusting state depending upon the result detected by the surrounding environment sensor 70. Therefore, the sounds can be automatically adjusted at one time for a change in the surrounding environment that affects the sounds in common. When the surrounding environment sensors 70 are provided in a plural number so as to separately detect the surrounding environments on the driver's seat side and on the assistant driver's seat side in common, the sounds can be adjusted automatically and suitably for a change in the environment that gives different effects depending upon the driver's seat side and the assistant driver's seat side. In this constitution, the sound adjusting conditions can be suitably set depending upon a change in the surrounding environment. Further, even when the surrounding environment suddenly changes, the sounds can be quickly adjusted to meet, for example a sharp change in the surrounding environment, such as traveling through a tunnel with the windows being opened.

Next, described below with reference to FIG. 23 is a sound adjust processing at the start by the acoustic control unit 1a in the multi-view display device shown in FIGS. 10 and 12. This flowchart is executed by the acoustic control unit 1a when the power source of the multi-view display device is turned on (or when the single-view display is changed over to the multi-view display) by using the operating section 6a. At step S22b, predetermined sound adjust setpoints that will be described later are written into the sound adjusting state storage unit 12a (first sound adjust setpoint storage unit 17 and second sound adjust setpoint storage unit 18), and sound adjust instructions corresponding to the sound adjust setpoints that are written are output to the corresponding sound volume/tone quality adjusting unit 33 to end the processing. In this processing, the sounds are set to the sound adjusting states based on predetermined sound adjust setpoints when the power source of the multi-view display device is turned on (or when the single-view display is changed over to the multi-view display), omitting the work for sound adjustment.

Next, described below is a predetermined sound adjust setpoint described above. As the predetermined sound adjust setpoint, there can be exemplified an initial sound adjust setpoint stored in advance by the manufacturer in the setpoint holding section 15a (corresponds to initial adjust setpoint storage unit), a sound adjust setpoint that meets predetermined conditions among the sound adjust setpoints stored in the setpoint holding section 15a (corresponds to the initial adjust setpoint storage unit) by the user as described with reference to FIG. 21 above, a sound adjust setpoint (also called “last memory”) stored in the setpoint holding section 15a (corresponds to initial adjust setpoint storage unit) when the power source of the display device is turned off (or when the multi-view display is changed over to the single-view display), and a sound adjust setpoint that meets predetermined conditions among the sound adjust setpoints stored in the setpoint holding section 15a (corresponds to the initial adjust setpoint storage unit) when the power source of the display device that will be described later is turned off (or when the multi-view display is changed over to the single-view display).

When the above predetermined sound adjust setpoints are initial sound adjust setpoints that have been stored in advance in the setpoint holding section 15a (corresponds to the initial adjust setpoint storage unit) by the manufacturer, the first and second sounds are adjusted by using the initial sound adjust setpoints stored in advance in the setpoint holding section 15a. Therefore, the initial adjusting states of the sounds are automatically elected, omitting the work for sound adjustment.

When the predetermined sound adjust setpoints are sound adjust setpoints of when the power source of the display device is turned off (or when the multi-view display is changed over to the single-view display), the sound adjust setpoints in the sound adjusting state storage unit 12a (first sound adjust setpoint storage unit 17 and second sound adjust setpoint adjust storage unit 18) may be once stored in the setpoint holding section 15a (corresponds to the initial adjust setpoint storage unit) when the power source of the display device is turned off (or when the multi-view display is changed over to the single-view display), and the sound adjust setpoints that have been stored may be read out at the start and may be written into the first sound adjust setpoint storage unit 17 and into the second sound adjust setpoint storage unit 18. Alternatively, when the power source of the display device is turned off (or when the multi-view display is changed over to the single-view display), the sound adjust setpoints that have been set to the first sound adjust setpoint storage unit 17 and to the second sound adjust setpoint storage unit 18 may be maintained so as not to be extinguished (in this case, the above-mentioned write processing is not necessary). In this constitution, the sound adjust setpoints are set to the sound adjusting states that had been used prior to turning the power source of the display device off (or prior to changing the multi-view display over to the single-view display), making it possible to select the sound adjusting states which are highly probable to be continuously used while omitting the work for sound adjustment.

Further, when the predetermined sound adjust setpoint is a sound adjust setpoint stored in the setpoint holding section 15a by the user as described in FIG. 21 above or is a sound adjust setpoint that meets predetermined conditions among the sound adjust setpoints stored in the setpoint holding section 15a when the power source of the display device that will be described later is turned off (or when the multi-view display is changed over to the single-view display), the sound adjust setpoint that is set is highly probable to use at least one of the conditions of the surrounding environment, the frequency, the last source of the like when the power source of the multi-view display device is turned on (or when the single-view display is changed over to the multi-view display). It is, thus, made possible to select a sound adjusting state that is highly probable to be used, omitting the work for sound adjustment.

The above processing corresponds to the initial sound-adjusting unit.

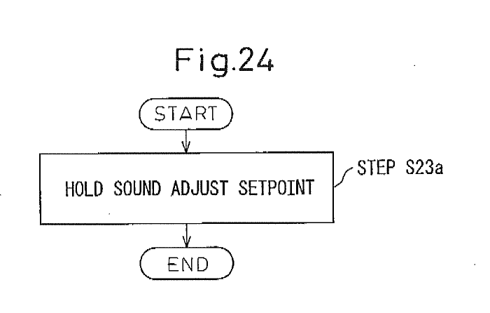

Next, described below with reference to FIG. 24 is the processing for storing the sound adjust setpoints by acoustic control unit la when the power source of the multi-view display device shown in FIGS. 10 and 12 is turned off (when the ignition is turned off, or when the multi-view display is changed over to the single-view display). Described below is the sound adjust processing at the start. This flow chart is executed when the acoustic control unit la has detected an instruction for turning the power source of the multi-view display device off (instruction for turning the ignition off)(or an instruction for changing the multi-view display over to the single-view display) from the operating section 6a. That is, the flowchart is executed when the user has turned off the power source of the multi-view display device, has turned off the ignition, or has changed the multi-view display over to the single-view display. This flowchart is different from that of FIG. 21 concerning only the timing for execution.

At step S23a, a sound adjust setpoint at a moment when the power source of the multi-view display device is turned off (ignition is turned off, or the multi-view display is changed over to the single-view display) is stored in the setpoint holding section 15a to end the processing. As for the storage method, the sound adjust setpoints are stored in a form as shown in (b) portion of FIG. 21 described above. Like in (b) portion of FIG. 21, the sound adjust setpoint and at least one of the other items may be stored in a pair. This constitution stores a sound adjust setpoint (sound adjust setpoint with which the user is satisfied) adjusted by the user depending upon the surrounding environment. By using the stored sound adjust setpoint for the processings of FIGS. 22 and 23, therefore, the sound adjustment can be effected more suitably from the next time.

The acoustic control unit 1a in the multi-view display device of FIGS. 10 and 12 makes it possible to execute the above-mentioned sound adjust processing by reading the above program (flowchart) stored in the program storage unit 11a or by using the above program (flowchart) stored in the RAM or ROM incorporated in the acoustic control unit 1a.

More concretely, the program (flowchart) stored in the RAM or ROM incorporated in the program storage unit 11a or in the acoustic control unit 1a of the multi-view display device of FIGS. 10 and 12, includes a sound adjust processing for adjusting the first sound corresponding to the first image and a sound adjust processing for adjusting the second sound corresponding to the second image in a display device capable of displaying an image (first image) on a first display region which can be observed from a first direction and an image (second image) on a second display region which can be observed from a second direction.

Desirably, the program (flowchart) stored in the RAM or ROM incorporated in the program storage unit 11a or in the acoustic control unit 1a of the multi-view display device of FIGS. 10 and 12, includes a rewrite processing for rewriting the sound adjust setpoint in the first sound adjust setpoint storage unit that stores the first sound adjust setpoint for the operation for adjusting the first sound corresponding to the image (first image) displayed on the first display region that can be observed from the first direction and a rewrite processing for rewriting the sound adjust setpoint in the second sound adjust setpoint storage unit that stores the second sound adjust setpoint for the operation for adjusting the second sound corresponding to the image (second image) displayed on the second display region that can be observed from a second direction.

Concerning the industrial applicability, the present invention is not limited to the flat panel-type liquid crystal display devices only having a function for adjusting the sound volume and the tone quality of acoustic signals but can further be applied to cathode-ray tube display devices, as well. Further, the flat panels are not limited to the liquid crystal display panels only but may also be the plasma display panels and organic EL (electronic luminescence) display panels.

Moreover, the present invention is not limited to car navigation devices only having a function for adjusting the sound volume and the tone quality of acoustic signals, but can be applied to any equipment furnished with any sections capable of offering a multi-view display ranging from such familiar devices as cell phones, PDAs, personal computers and TV receivers through up to measuring instruments, medical equipment and industrial machinery in general, Further, the invention is not limited to the two-dimensional (2D) displays only but can also be applied even to the three-dimensional (3D) displays which are capable of displaying a solid image by enabling both eyes of a viewer to view different images.

1. A display device comprising:
a display section which displays individual images in a plurality of viewing ranges on a common screen;
a sound producing section which produces sounds each corresponding to the individual images displayed in each of the viewing ranges; and
a sound adjusting section which independently adjusts the sounds.

2. A display device according to claim 1, wherein said sound adjusting section applies a sound adjusting state for one of the viewing ranges as a sound adjusting state for another of the viewing ranges.

3. A display device according to claim 1, wherein said sound adjusting section interchanges a sound adjusting state for one of the viewing ranges and a sound adjusting state for another of the viewing ranges.

4. A display device according to claim 1, further comprising a preset data storing section which stores sound setting values each corresponding to the one of the viewing ranges, wherein said sound adjusting section independently adjusts each of the sounds on the basis of the sound setting values.

5. A display device according to claim 1, further comprising a preset data registering section which stores sound setting values each corresponding to one of the viewing ranges in response to a user's operation, wherein said sound adjusting section independently adjusts each of the sounds on the basis of the sound setting values.

6. A display device according claim 1, wherein said sound adjusting section has a common mode in which the sounds are commonly adjusted and a individual mode in which each of the sounds is adjusted independently.

7. A display device according to claim 1, further comprising a common sensor which detects a state of a surrounding environment in the viewing ranges, wherein said sound adjusting section adjusts the sounds on the basis of the detected state.

8. A display device according to claim 1, further comprising a plurality of sensors each of which detects a state of a surrounding environment in corresponding one of the viewing ranges, wherein said sound adjusting section independently adjusts corresponding one of the sounds on the basis of the detected state.

9. A display device according to claim 1, wherein said sound producing section produces a predetermined sound while the sound is adjusted.

10. A display device according to claim 1, wherein said sound producing section allows an output of one of the sounds to be adjusted and turns off the other sound while one of the sounds is adjusted.

11. A display device according to claim 1, further comprising an initial setting value storage section which stores a plurality of initial setting values each corresponding to one of the viewing ranges, wherein said sound adjusting section adjusts the sounds on the basis of the initial setting values when the display device is turned on.

12. A display device according to claim 1, further comprising a frequency storage section which store each frequency of a sound adjustment in each of the viewing ranges, wherein said sound adjusting section adjusts each of the sounds on the basis of the stored frequencies.

13. A display device according to claim 11, wherein sound setting values are stored in the initial setting value storage section before the display device is turned off.

14. A display device according to claim 1, wherein said sound adjusting section adjusts a volume of each of the sounds.

15. A display device according to claim 1, wherein said sound adjusting section adjusts frequency characteristics of each of the sounds.

16. A display device according to claim 14, wherein a maximum level of the volume of the sounds is limited at a predetermined level.

17. A method of adjusting sounds of a display device Comprising the steps of:
displaying images individually in a plurality of viewing ranges on a common screen;
producing sounds each corresponding to the individual images displayed in each of the viewing range; and
adjusting each of the sounds independently.

18. A method of adjusting sounds of a display device according to claim 17, further comprising the step of:
storing sound setting values each corresponding to the viewing ranges, wherein each of the sounds is adjusted on the basis of the sound setting values.
